(19) United States
(12) Patent Application Publication
(10) Pub. No.: US 2025/0155251 A1
(43) Pub. Date: May 15, 2025

(54) METHOD AND APPARATUS FOR DISPLAYING NAVIGATION ROUTE, COMPUTER DEVICE, AND STORAGE MEDIUM

(71) Applicant: TENCENT TECHNOLOGY (SHENZHEN) COMPANY LIMITED, Shenzhen (CN)

(72) Inventors: Long ZHANG, Shenzhen (CN); Weizheng Li, Shenzhen (CN); Hongchao Zhao, Shenzhen (CN); Wei Huang, Shenzhen (CN); Chunhua Lv, Shenzhen (CN)

(73) Assignee: TENCENT TECHNOLOGY (SHENZHEN) COMPANY LIMITED, Shenzhen (CN)

(21) Appl. No.: 19/027,005

(22) Filed: Jan. 17, 2025

Related U.S. Application Data
(63) Continuation of application No. PCT/CN2023/130008, filed on Nov. 6, 2023.

(30) Foreign Application Priority Data
Jan. 18, 2023 (CN) 20231011908.6

(51) Int. Cl. G01C 21/34; G01C 21/36

(52) U.S. Cl. CPC G01C 21/3469; G01C 21/3605; G01C 21/367; G01C 21/3673; G01C 21/3682; G01C 21/3697

(57) ABSTRACT

A method for displaying a navigation route, performed by a user terminal, includes displaying, for performing navigation planning with respect to a vehicle, a start point label indicating a start location of the navigation planning and an end point label indicating an end location of the navigation planning; displaying at least one navigation route planned from the start point label to the end point label; and displaying, for a target navigation route in the at least one navigation route, a first energy replenishment location label indicating a waypoint of the target navigation route, on the target navigation route, wherein the waypoint corresponds to a driving energy replenishment location for the vehicle.

### CROSS-REFERENCE TO RELATED APPLICATIONS

This application is a continuation application of International Application No. PCT/CN2023/130008 filed on Nov. 6, 2023, which claims priority to Chinese Patent Application No. 202310119028.6, filed with the China National Intellectual Property Administration on Jan. 18, 2023, the disclosures of each being incorporated by reference herein in their entireties.

### FIELD

The disclosure relates to the field of computer technologies, and in particular, to a method and apparatus for displaying a navigation route, a computer device, and a storage medium.

### BACKGROUND

With the development of society, road traffic has become increasingly intricate. Therefore, when traveling, people may complete route planning using electronic map applications. Route planning is generally defined as a problem of finding one or more routes from a specified start point to a specified end point.

When route planning is used, a start point and an end point may be inputted into an electronic map application, so that the electronic map application can display a navigation route including a start point label and an end point label. However, only the start point label and the end point label may be displayed, resulting in low diversity of label display.

### SUMMARY

Some embodiments provide a method and apparatus for displaying a navigation route, a computer device, a storage medium, and a computer program product.

According to an aspect of the disclosure, a method for displaying a navigation route, performed by a user terminal, includes displaying, for performing navigation planning with respect to a vehicle, a start point label indicating a start location of the navigation planning and an end point label indicating an end location of the navigation planning; displaying at least one navigation route planned from the start point label to the end point label; and displaying, for a target navigation route in the at least one navigation route, a first energy replenishment location label indicating a waypoint of the target navigation route, on the target navigation route, wherein the waypoint corresponds to a driving energy replenishment location for the vehicle.

According to an aspect of the disclosure, an apparatus for displaying a navigation route, includes at least one memory configured to store computer program code; and at least one processor configured to read the program code and operate as instructed by the program code, the program code including location label display code configured to cause at least one of the at least one processor to display, for performing navigation planning with respect to a vehicle, a start point label indicating a start location of the navigation planning and an end point label indicating an end location of the navigation planning; planned route code configured to cause at least one of the at least one processor to display at least one navigation route planned from the start point label to the end point label; and energy location code configured to cause at least one of the at least one processor to display, for a target navigation route in the at least one navigation route, a first energy replenishment location label indicating a waypoint of the target navigation route, on the target navigation route, wherein the waypoint corresponds to a driving energy replenishment location for the vehicle.

According to an aspect of the disclosure, a non-transitory computer-readable storage medium, storing computer code which, when executed by at least one processor, causes the at least one processor to at least display, for performing navigation planning with respect to a vehicle, a start point label indicating a start location of the navigation planning and an end point label indicating an end location of the navigation planning; display at least one navigation route planned from the start point label to the end point label; and display, for a target navigation route in the at least one navigation route, a first energy replenishment location label indicating a waypoint of the target navigation route, on the target navigation route, wherein the waypoint corresponds to a driving energy replenishment location for the vehicle.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a diagram of an application environment of a method for displaying a navigation route according to some embodiments.

FIG. 2 is a schematic flowchart of a method for displaying a navigation route according to some embodiments.

FIG. 3 is a schematic diagram of display of a start location and an end location according to some embodiments.

FIG. 4 is a schematic diagram of display of location labels according to some embodiments.

FIG. 5 is a schematic diagram of a waypoint according to some embodiments.

FIG. 6 is a schematic diagram of an initial page according to some embodiments.

FIG. 7 is a schematic diagram of display of vehicle information according to another embodiment.

FIG. 8 is a schematic diagram of display of a navigation route according to some embodiments.

FIG. 9 is a schematic diagram of switching a navigation route according to some embodiments.

FIG. 10 is a schematic diagram of display of label information according to some embodiments.

FIG. 11 is a schematic diagram of determining candidate driving energy replenishment locations according to some embodiments.

FIG. 12 is a schematic diagram of an energy consumption curve according to some embodiments.

FIG. 13 is a schematic diagram of prompting a risk of being unreachable according to some embodiments.

FIG. 14 is a schematic flowchart of a method for displaying a navigation route according to some embodiments.

FIG. 15 is a schematic diagram of a framework of displaying a navigation route according to some embodiments.

FIG. 16 is a structural block diagram of an apparatus for displaying a navigation route according to some embodiments.

FIG. 17 is a structural block diagram of an apparatus for displaying a navigation route according to another embodiment.

FIG. 18 is a diagram of an internal structure of a computer device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

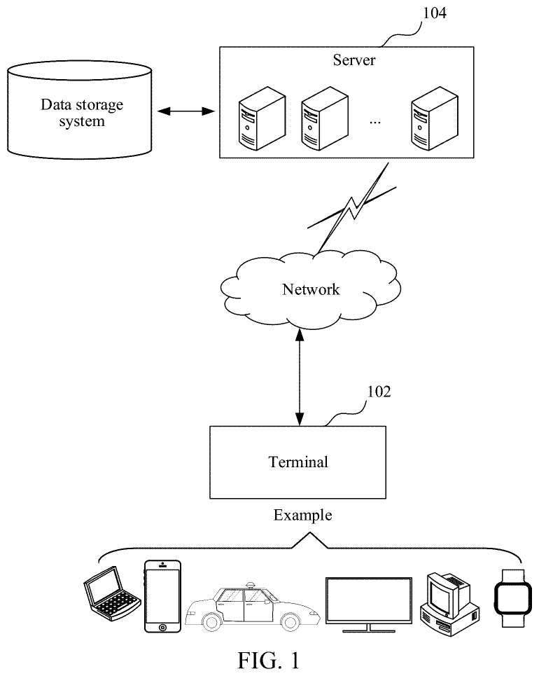

A method for displaying a navigation route provided in some embodiments may be applied to an application environment shown in FIG. 1. A terminal 102 communicates with a server 104 through a network. A data storage system may store data that the server 104 is to process. The data storage system may be integrated on the server 104 or arranged on the cloud or another server. The terminal 102 may independently perform the method for displaying a navigation route provided in some embodiments, or the terminal 102 and the server 104 may be configured in cooperation to perform the method for displaying a navigation route provided in some embodiments. Descriptions are provided by using an example in which the terminal 102 and the server 104 are configured in cooperation to perform the method for displaying a navigation route provided in some embodiments. An electronic map application may be run in the terminal 102, and the server 104 may be a backend server of the electronic map application. A user may input a start point and an end point of a to-be-planned navigation route through the electronic map application in the terminal 102. Therefore, the terminal 102 may transmit the start point and the end point inputted by the user to the server 104, so that the server 104 performs route planning based on the received start point and end point, to generate at least one navigation route, and transmits route data of the generated at least one navigation route to the terminal 102. The terminal 102 displays the at least one navigation route based on the received route data, and displays, on a target navigation route in the at least one navigation route, an energy replenishment location label used as a waypoint of the target navigation route. The terminal 102 may be, but not limited to, various in-vehicle terminals, desktop computers, notebook computers, smartphones, tablet computers, Internet of Things devices, and portable wearable devices. The Internet of Things device may be a smart speaker, a smart television, a smart air conditioner, a smart in-vehicle device, or the like. The portable wearable device may be a smartwatch, a smart band, a head-mounted device, or the like. The server 104 may be implemented by using an independent server or a server cluster that includes a plurality of servers.

The disclosure relates to an intelligent traffic system (ITS). For example, navigation can be implemented through the method for displaying a navigation route. The ITS is also referred to as an intelligent transportation system and effectively and comprehensively applies advanced technologies (such as information technologies, computer technologies, data communication technologies, sensor technologies, electronic control technologies, automatic control theories, operations research, and artificial intelligence) to transportation, service control, and vehicle manufacturing, to strengthen connections among vehicles, roads, and users, thereby forming a comprehensive transportation system that ensures safety, improves efficiency, improves the environment, and saves energy.

The “first”, the “second”, and similar terms used, do not indicate any order, quantity, or significance, but are used to only distinguish different components. Unless the context clearly indicates otherwise, singular forms, such as “a”, “an”, or “the”, do not indicate a quantity limitation, but indicate the presence of at least one. A quantity indicated by “a plurality of”, “multiple”, or the like mentioned in some embodiments is a quantity of “at least two”. For example, “a plurality of” is “at least two”, and “multiple” is also “at least two”.

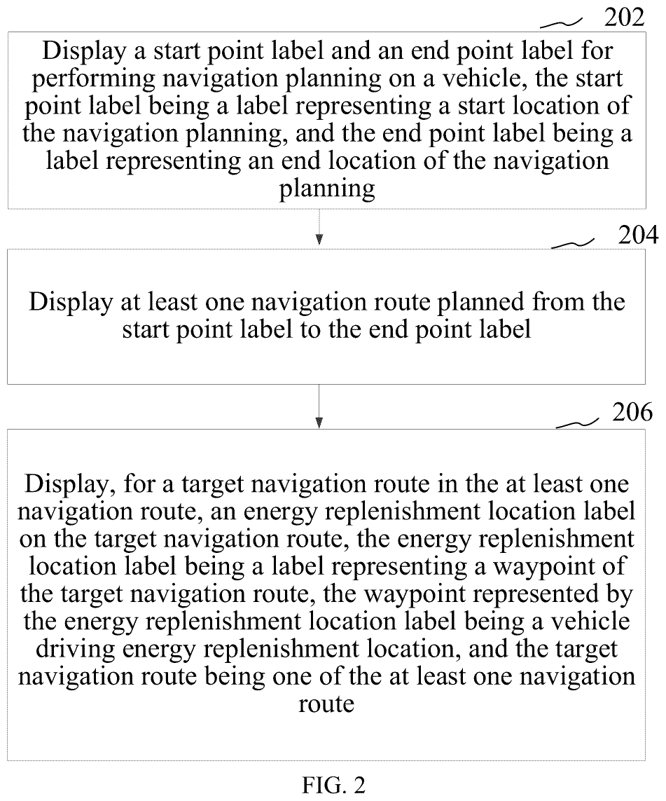

In some embodiments, as shown in FIG. 2, a method for displaying a navigation route is provided. Descriptions are provided using an example in which the method is applied to the terminal in FIG. 1. The following operations are included:

Operation 202: Display a start point label and an end point label for performing navigation planning on a vehicle, the start point label being a label representing a start location of the navigation planning, and the end point label being a label representing an end location of the navigation planning.

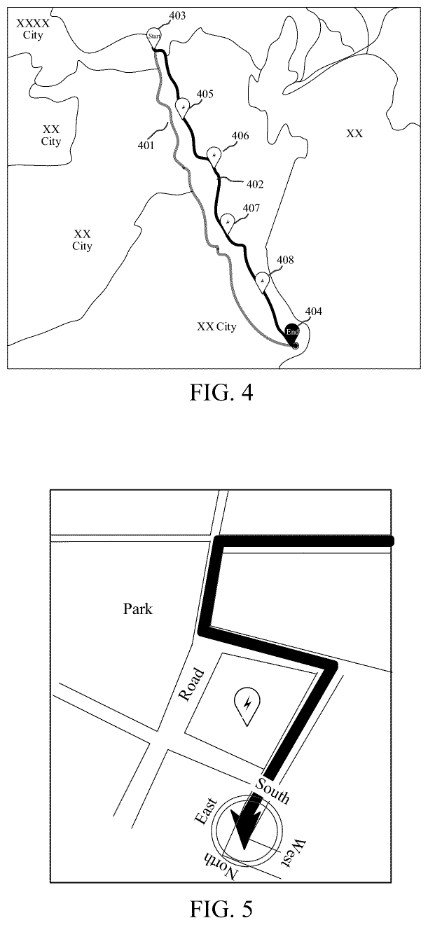

When navigation is to be used, the terminal may obtain a start point and an end point for performing navigation planning on the vehicle, and display a start point label corresponding to the start point and an end point label corresponding to the end point. For example, a target vehicle is used below as an example for description. The target vehicle may be any vehicle using navigation. The terminal may be an in-vehicle terminal of the target vehicle, and have an electronic map application run therein. When navigation is to be used, an owner of the target vehicle may input a start point and an end point in the electronic map application, so that the electronic map application displays a start point label corresponding to the start point inputted by the owner and an end point label corresponding to the end point inputted by the owner. The owner of the target vehicle may input only the end point. A positioning application is deployed in the in-vehicle terminal, a current location of the target vehicle can be obtained through the positioning application, and the current location of the target vehicle is used as the start point. The start point label corresponding to the start point and the end point label corresponding to the end point inputted by the owner are displayed in the electronic map application. The label may be an icon. The start point label is an icon representing a start location of the navigation planning, and the end point label is an icon representing an end location of the navigation planning. For example, in FIG. 4, 403 is the start point label, and 404 is the end point label.

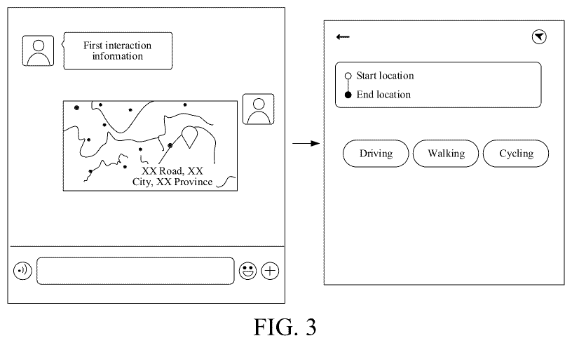

In some embodiments, before displaying the start point label and the end point label, the terminal may further display a start location corresponding to the start point label and an end location corresponding to the end point label. Referring to FIG. 3, an instant messaging application may be run in the terminal, and the instant messaging application may receive a positioning card sent by a friend. The terminal obtains, in response to a trigger operation performed by the owner on the positioning card, a location to which the positioning card points, and displays the location to which the positioning card points as the end location and the current position of the target vehicle as the start location in the electronic map application. FIG. 3 is a schematic diagram of display of a start location and an end location according to some embodiments.

In some embodiments, when driving the target vehicle for a long distance, the owner may trigger the terminal to display a home page of the electronic map application, and input a start location and an end location in the home page of the electronic map application through voice input, so that the terminal can display a corresponding start point label and a corresponding end point label.

Operation 204: Display at least one navigation route planned from the start point label to the end point label

When displaying the start point label and the end point label, the terminal may further display at least one navigation route planned from the start point label to the end point label. For example, the terminal may display, in a navigation map, at least one navigation route pointing from the start point label to the end point label.

Operation 206: Display, for a target navigation route in the at least one navigation route, an energy replenishment location label on the target navigation route, the energy replenishment location label being a label representing a waypoint of the target navigation route, the waypoint represented by the energy replenishment location label being a driving energy replenishment location of the vehicle, and the target navigation route being one of the at least one navigation route.

For the target navigation route in the at least one navigation route, the start point label, the end point label, and the energy replenishment location label may be displayed on the target navigation route. An energy replenishment location to which the energy replenishment location label points is a waypoint of the target navigation route. The energy replenishment location is a location for replenishing driving energy of the target vehicle. The driving energy is energy for driving the vehicle to travel. For example, the driving energy may be gasoline, electric energy, or the like. The navigation route is a route from the start location to the end location. For example, referring to FIGS. 4, 401 and 402 in FIG. 4 are navigation routes.

In some embodiments, the energy replenishment location is a location for replenishing driving energy of the target vehicle, and is also a waypoint. The waypoint of the navigation route is a location to be passed during traveling along the navigation route. Correspondingly, the energy replenishment location label is a label displayed in an electronic map to represent an energy replenishment location. The energy replenishment location label may be configured to represent a waypoint, and may be further configured to represent an energy replenishment location.

In some embodiments, the target navigation route may be a recommended navigation route in the at least one navigation route, a navigation route selected by the owner from the at least one navigation route, or any navigation route in the at least one navigation route.

In some embodiments, referring to FIG. 4, the terminal may display navigation routes 401 and 402 in a navigation map, and display, on a target navigation route, a start point label 403, an end point label 404, and energy replenishment location labels 405 to 408 located between the start point label and the end point label. FIG. 4 is a schematic diagram of display of location labels according to some embodiments.

In some embodiments, for an energy replenishment location label displayed on the target navigation route, a location to which the energy replenishment location label points is a waypoint of the target navigation route. For example, referring to FIG. 5, the target navigation route will pass a location to which an energy replenishment location label points. FIG. 5 is a schematic diagram of a waypoint according to some embodiments.

In some embodiments, while the at least one navigation route is displayed, attribute information of each navigation route may be further displayed. The attribute information may include a total duration, total kilometers, a quantity of traffic lights, and the like. For example, the terminal may display attribute information corresponding to each navigation route. Moreover, the target navigation route may be a recommended navigation route determined based on comprehensive attribute information. For example, the target navigation route may be a navigation route with a shortest duration in the at least one navigation route, so that the terminal may display a location label sequence on the target navigation route, to prompt, based on the location label sequence, the owner of locations that the target navigation route will pass.

In some embodiments, each of the at least one navigation route may be referred to as a target navigation route, so that a corresponding location label sequence is displayed on each navigation route displayed. Energy replenishment location labels displayed on all navigation routes may not be completely the same. First n recommended navigation routes in the at least one navigation route may be referred to as target navigation routes, n being a preset quantity, and corresponding energy replenishment location labels are displayed on the target navigation routes.

In some embodiments, the target vehicle has a remaining driving energy amount and a storage capacity. For the target navigation route in the at least one navigation route, a location label sequence from the start point label to the end point label is displayed on the target navigation route. The location label sequence includes an energy replenishment location label located between the start point label and the end point label. In the location label sequence, an estimated energy consumption amount of a section between first two location labels is not greater than the remaining driving energy amount, and an estimated energy consumption amount of a section between any adjacent energy replenishment location labels is not greater than the storage capacity. Because the estimated energy consumption amount of the section between the first two location labels is not greater than the remaining driving energy amount, the owner can drive the target vehicle and successfully arrive at a location represented by the second location label based on the remaining driving energy amount in the target vehicle. Because the estimated energy consumption amount of the section between any adjacent energy replenishment location labels is not greater than the storage capacity, after the target vehicle is replenished with driving energy at an energy replenishment location, the owner can drive, based on driving energy possessed by the target vehicle, the target vehicle to successfully arrive at a neighboring energy replenishment location adjacent to the current energy replenishment location from the current energy replenishment location. In this way, the target vehicle is driven to successfully arrive at the end location from the start location of the target navigation route.

The location label sequence includes a plurality of location labels. The location label is a label for representing a location. The location label sequence includes at least one of a location label representing a start location, a location label representing an end location, and a location label representing a driving energy replenishment location. For the convenience of description, in the following, the location label representing the start location is referred to as a start point label, the location label of the end location is referred to as an end point label, and the location label of the driving energy replenishment location is referred to as an energy replenishment location label. For example, referring to FIG. 4, a location label sequence may be displayed in the electronic map. The location label sequence includes a start point label 403, an end point label 404, and energy replenishment location labels 405 to 408.

The adjacent energy replenishment location labels are adjacent energy replenishment location labels in a plurality of location labels in the location label sequence. As shown in FIG. 4, because the location label sequence is displayed on the navigation route, there is a front-back positional relationship between location labels. For example, the adjacent energy replenishment location labels may be 405 and 406 in FIG. 4.

The estimated energy consumption amount is an estimated amount of energy that the target vehicle may consume when traveling from a location to which one location label in adjacent location labels points to a location to which the other location label points. For example, referring to FIG. 4, the estimated energy consumption amount may be an amount of energy that the target vehicle may consume after traveling from a location to which 405 points to a location to which 406 points. When the energy is electric energy, the estimated energy consumption amount is an amount of power that the target vehicle may consume after traveling from the location to which 405 points to the location to which 406 points.

The energy storage space is a storage space on the vehicle for storing driving energy. For example, the energy storage space may be a battery, a fuel tank, or the like. The remaining driving energy amount is a driving energy amount remaining in the energy storage space of the target vehicle. The storage capacity is a total amount of driving energy that can be released from the energy storage space of the target vehicle. When the storage capacity space is a battery, the remaining driving energy amount is a remaining power amount, and the storage capacity is a battery capacity. When the storage capacity space is an fuel tank, the remaining driving energy amount is a remaining fuel amount, and the storage capacity is a fuel tank capacity.

In some embodiments, the energy replenishment location label in the displayed location label sequence may represent a waypoint of the target navigation route. For example, referring to FIG. 4, an energy replenishment location label 405 may represent that when traveling along the target navigation route, the target vehicle will pass a location to which the energy replenishment location label 405 points.

For a target navigation route in the at least one navigation route, a location label sequence from a start location to an end location may be displayed on the target navigation route. When the location label sequence includes more than two location labels, the location label sequence may include the start point label, the end point label, and an energy replenishment location label. When the location label sequence includes two location labels, the two location labels included in the location label sequence may be the start point label and the end point label. When the location label sequence includes more than two location labels, an estimated energy consumption amount of a section between first two location labels is not greater than the remaining driving energy amount. For example, referring to FIG. 4, the first two location labels may be a start point label 403 and an energy replenishment location label 404, and the estimated energy consumption amount of the section between the start point label 403 and the energy replenishment location label 404 is not greater than the remaining driving energy amount in the energy storage space. Because the estimated energy consumption amount of the section between the first two location labels is not greater than the remaining driving energy amount, a location to which a latter location label in the first two location labels points is reachable, and the target vehicle can travel from the start location to the location to which the latter location label points based on the remaining driving energy amount. For example, the target vehicle can travel, based on a current remaining power amount, from the start location to a charging station to which the energy replenishment location label 403 points, to perform a first round of power replenishment at the charging station to which the energy replenishment location label 404 points, to perform subsequent traveling based on replenished power.

When the location label sequence includes more than two location labels, an estimated energy consumption amount of a section between any adjacent energy replenishment location labels in the location label sequence is not greater than the storage capacity. For example, referring to FIG. 4, when the adjacent energy replenishment location labels may be an energy replenishment location label 405 and an energy replenishment location label 406, the target vehicle may be first charged at a charging station to which the energy replenishment location label 405 points. In this case, a maximum charging amount may be the battery capacity, so that the battery capacity can support the target vehicle to travel from the charging station to which the energy replenishment location label 405 points to a charging station to which the energy replenishment location label 406 points. Because an estimated energy consumption amount of any adjacent energy replenishment location labels is not greater than the storage capacity, the target vehicle can travel, based on energy replenished at a location to which a former energy replenishment location label in the adjacent energy replenishment location labels points, to a location to which a latter energy replenishment location label in the adjacent energy replenishment location labels points. Therefore, the location to which the latter target energy replenishment location label in the adjacent energy replenishment location labels points is reachable. Because a location to which an energy replenishment location label displayed on the target navigation route points is reachable, the displayed energy replenishment location label is more accurate, thereby greatly improving the user experience and facilitating a user in planning vehicle driving energy based on the displayed energy replenishment location label.

In the foregoing method for displaying a navigation route, by displaying the start point label and the end point label, at least one navigation route planned from the start point label to the end point label can be displayed. By displaying at least one navigation route, on a target navigation route in the at least one navigation route, an energy replenishment location label representing a waypoint of the target navigation route can be displayed. Because the start point label, the end point label, and the energy replenishment location label are displayed on the target navigation route, diversity of displayed location labels is improved. Because the energy replenishment location label is displayed on the target navigation route as a waypoint, the owner can perform driving energy replenishment during traveling along the target navigation route, and may not detour to another energy replenishment location for energy replenishment, thereby reducing energy consumed by detouring.

In some embodiments, the displaying a start point label and an end point label for performing navigation planning on a vehicle includes: displaying a navigation map and a navigation trigger control in response to a navigation map display operation; and displaying the start point label and the end point label in the navigation map in response to a trigger operation on the navigation trigger control.

The terminal may display a navigation map and a navigation trigger control in response to a navigation map display operation. For example, when the owner starts the electronic map application, the terminal may display the navigation map and the navigation trigger control in response to the operation of starting the electronic map. The operation of starting the electronic map is the navigation map display operation. The navigation trigger control is a control for triggering navigation. For example, when the owner clicks/taps the navigation trigger control, the terminal may display a navigation route.

In the foregoing embodiment, the start point label and the end point label are displayed in the navigation map, so that the owner can intuitively view the start location and the end location of the navigation planning, thereby greatly improving the efficiency of viewing the start location and the end location of the navigation planning.

In some embodiments, the displaying a navigation map in response to a navigation map display operation includes: displaying an initial page in response to the navigation map display operation, a start point input box, an end point input box, the navigation trigger control, and the navigation map being displayed in the initial page; and in response to input operations on the start point input box and the end point input box, displaying the start location in the start point input box, and displaying the end location in the end point input box. The displaying the start point label and the end point label in the navigation map in response to a trigger operation on the navigation trigger control includes: displaying, in response to the trigger operation on the navigation trigger control, the start point label corresponding to the start location and the end point label corresponding to the end location in the navigation map.

The terminal may display an initial page in response to the navigation map display operation, a start point input box, an end point input box, the navigation trigger control, and the navigation map being displayed in the initial page. For example, referring to FIG. 6, the terminal may display a start point input box and end point input box 601, a navigation trigger control 602, and the navigation map 603 in the initial page. Further, the owner may input the start location of the navigation planning in the start point input box, input the end location of the navigation planning in the end point input box, and click/tap the navigation trigger control, to cause the terminal to display the start point label corresponding to the inputted start location and the end point label corresponding to the end location in the navigation map, for example, display the start location label representing the start location and the end location label representing the end location. In this case, the terminal may further display at least one navigation route planned from the start point label to the end point label. FIG. 6 is a schematic diagram of an initial page according to some embodiments.

In the foregoing embodiment, the start point input box and the end point input box are displayed, so that the owner can input the start location in the start point input box and the end location in the end point input box, to enable the start location label and the end location label to be generated based on the inputted start location and end location.

In some embodiments, the displaying at least one navigation route planned from the start point label to the end point label includes: displaying vehicle information of the vehicle, the vehicle information including a remaining driving energy amount and a storage capacity of the vehicle, the storage capacity being a capacity of an energy storage space configured for storing driving energy of the vehicle; and displaying, in response to a confirmation operation on the vehicle information, the at least one navigation route planned from the start point label to the end point label.

Because a location to which the energy replenishment location label points displayed on the target navigation route is reachable, at least one navigation route may be planned based on the remaining driving energy amount and the storage capacity of the target vehicle. Therefore, before the at least one navigation route is displayed, the remaining driving energy amount and the storage capacity of the target vehicle may be confirmed, so that the at least one navigation route is subsequently determined based on the confirmed remaining driving energy amount and storage capacity. When information is to be confirmed, the terminal may display the vehicle information of the target vehicle. The vehicle information includes the remaining driving energy amount and the storage capacity of the target vehicle. The terminal generates, in response to a confirmation operation performed by the owner on the vehicle information, at least one navigation route based on the confirmed vehicle information, and displays the generated at least one navigation route.

In some embodiments, the terminal may directly obtain the remaining driving energy amount and the storage capacity of the target vehicle from an information obtaining interface of the target vehicle, or the owner may input the remaining driving energy amount and the storage capacity of the target vehicle, so that the terminal can display the remaining driving energy amount and the storage capacity.

In the foregoing embodiment, after determining that the remaining driving energy amount and the storage capacity are accurate, the at least one navigation route generated based on the remaining driving energy amount and the storage capacity is displayed, so that the displayed navigation route is accurate.

In some embodiments, the displaying vehicle information of the vehicle includes: displaying an information input page, and displaying, in response to an input operation on the information input page, the vehicle information of the vehicle.

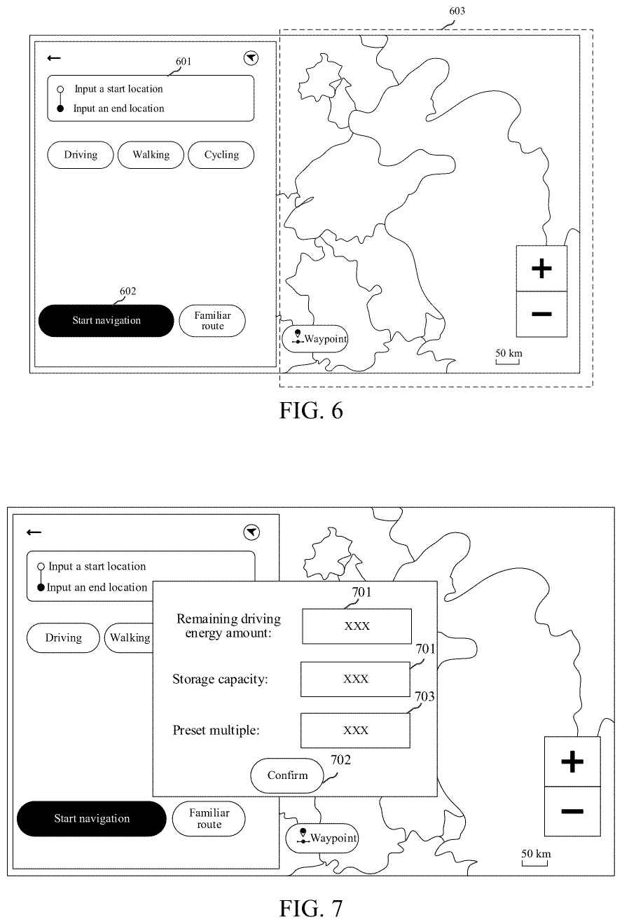

The terminal may display an information input page. Referring to FIG. 7, a vehicle information input box 701 and a confirm control 702 are displayed in the information input page. The owner may input vehicle information in the vehicle information input box 701, and trigger confirmation of the vehicle information through a click/tap operation on the confirm control 702. The operation of inputting the vehicle information in the vehicle information input box is the input operation on the information input page. FIG. 7 is a schematic diagram of display of vehicle information according to another embodiment.

In the foregoing embodiment, the information input page is displayed, which can facilitate the owner in inputting the vehicle information, thereby improving the efficiency of inputting the vehicle information.

In some embodiments, the target navigation route is a recommended navigation route or a switched-to navigation route to which a navigation route switching operation points. The displaying at least one navigation route planned from the start point label to the end point label includes: displaying the at least one navigation route planned from the start point label to the end point label, highlighting the recommended navigation route in the at least one navigation route, and displaying the energy replenishment location label on the recommended navigation route; and in response to the navigation route switching operation, switching from highlighting the recommended navigation route to highlighting the switched-to navigation route to which the navigation route switching operation points, and switching from displaying the energy replenishment location label on the recommended navigation route to displaying an energy replenishment location label on the switched-to navigation route.

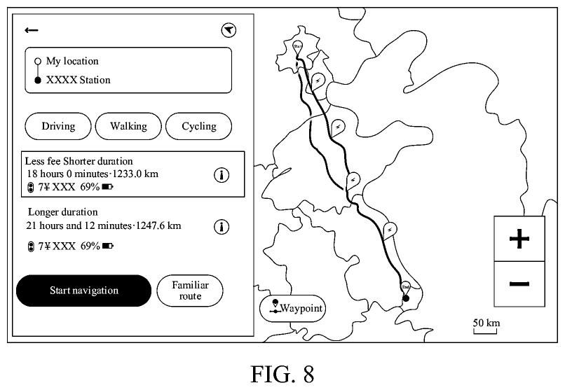

When the at least one navigation route is generated, the terminal may display the at least one navigation route. The terminal may highlight a recommended navigation route in the at least one navigation route, and display, on the recommended navigation route when the recommended navigation route is highlighted, a location label sequence including an energy replenishment location label. In this case, the target navigation route is the recommended navigation route. For example, referring to FIG. 8, the terminal may highlight a navigation route with a shorter duration, and display a location label sequence of the navigation route with the shorter duration. The recommended navigation route is a navigation route recommended by the terminal.

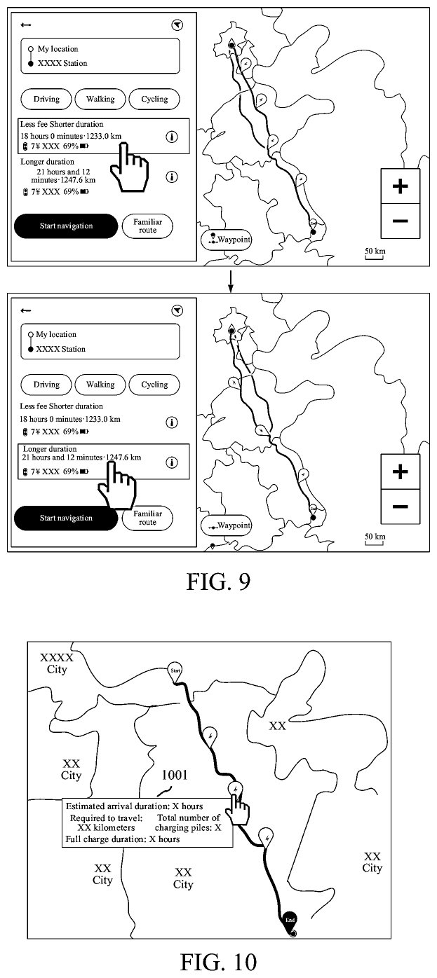

Further, the owner may switch the highlighted navigation route. The owner may perform navigation route switching by clicking/tapping attribute information of a to-be-switched-to navigation route. Therefore, the terminal switches, in response to a switching operation performed by the owner, from highlighting the recommended navigation route to highlighting a switched-to navigation route to which the navigation route switching operation points, and displays a location label sequence on the switched-to navigation route. In this case, the target navigation route is changed from the recommended navigation route to the switched-to navigation route. For example, referring to FIG. 9, the terminal may switch to displaying a location label sequence on a navigation route with a longer duration. The switched-to navigation route is a navigation route to which the navigation route switching operation points. For example, when the owner triggers the navigation route switching operation and expects to switch from highlighting a navigation route A to highlighting a navigation route B, the navigation route B is the navigation route to which the navigation route switching operation points. FIG. 8 is a schematic diagram of display of a navigation route according to some embodiments. FIG. 9 is a schematic diagram of switching a navigation route according to some embodiments.

In the foregoing embodiment, the target navigation route is selectively highlighted, and the target navigation route may be switched according to the navigation route switching operation performed by the owner. In this way, the displaying of the navigation route is made flexible, so that the highlighted target navigation route may change with the owner.

In some embodiments, the energy replenishment location label displayed on the recommended navigation route and the energy replenishment location label displayed on the switched-to navigation route are not completely the same.

The energy replenishment location label is a label of a driving energy replenishment location, and the driving energy replenishment location is a location for driving energy replenishment, for example, a gas station or a charging station.

When the location label sequence corresponding to the recommended navigation route includes more than two location labels, it may be considered that the location label sequence further includes at least one energy replenishment location label in addition to the start point label and the end point label. In this case, if the target vehicle travels based on the recommended navigation route, and a remaining driving energy amount of the target vehicle is not sufficient to support traveling to the end location, energy replenishment may be performed during the traveling to the end location. Correspondingly, when the location label sequence corresponding to the switched-to navigation route also includes more than two location labels, the location label sequence also includes at least one energy replenishment location label. The energy replenishment location label in the location label sequence corresponding to the recommended navigation route and the energy replenishment location label in the location label sequence corresponding to the switched-to navigation route are not completely consistent. In other words, each of the at least one navigation route has its own corresponding location label sequence, and energy replenishment location labels in the respective corresponding location label sequences are not completely the same. Therefore, when traveling from the start location to the end location along different navigation routes, the owner may pass different driving energy replenishment locations. In this way, the owner may select, one navigation route from the at least one navigation route for navigation.

In the foregoing embodiment, because energy replenishment location labels in location label sequences corresponding to different navigation routes may not be the same, diversity of driving energy replenishment locations is improved, so that the owner can select, a navigation route with an appropriate energy replenishment location label for navigation, thereby improving the flexibility of navigation.

In some embodiments, the method further includes: displaying label information corresponding to each energy replenishment location label, the label information including at least one of a time spent for driving energy of the vehicle to be replenished to a preset target amount, a time spent for the vehicle to travel to the energy replenishment location to which the corresponding energy replenishment location label points, and a quantity of energy replenishment devices at the energy replenishment location to which the corresponding energy replenishment location label points.

While the energy replenishment location label is displayed on the target navigation route, label information corresponding to each energy replenishment location label may be further displayed. The label information includes at least one of a time to be spent for driving energy of the target vehicle to be replenished to a preset target amount, a time spent for the target vehicle to travel to the energy replenishment location to which the corresponding energy replenishment location label points, and a quantity of energy replenishment devices at the energy replenishment location to which the corresponding energy replenishment location label points. The time to be spent for driving energy of the target vehicle to be replenished to a preset target amount is a time to be spent for replenishing the driving energy to a target amount when the target vehicle performs energy replenishment at a location to which a corresponding energy replenishment location label points. The target amount may be a preset amount. For example, the target amount may be a driving energy storage capacity.

In some embodiments, referring to FIG. 10, while the energy replenishment location label on the target navigation route is clicked/tapped, label information 1001 may be displayed at an empty position corresponding to the energy replenishment location label. FIG. 10 is a schematic diagram of display of label information according to some embodiments.

In the foregoing embodiment, by displaying the label information, the owner is enabled to learn of more information, which helps the owner to select, based on the displayed label information, a more appropriate navigation route from the at least one navigation route. In this way, the user experience is improved, and the accuracy of a navigation route finally configured for navigation is improved.

In some embodiments, before the displaying at least one navigation route planned from the start point label to the end point label, the foregoing method further includes a navigation route generation operation. The navigation route generation operation includes: obtaining road topology data, and generating at least one initial route from the start point label to the end point label based on the road topology data; obtaining driving energy replenishment location data; and generating one or more navigation routes respectively corresponding to the at least one initial route based on the driving energy replenishment location data.

When the navigation route is to be generated, the terminal may obtain road topology data, perform initial route planning based on the road topology data, and generate at least one initial route from the start location to the end location without considering a driving energy replenishment location. For example, a plurality of routes from the start location to the end location may be generated based on the road topology data, the plurality of routes are scored with reference to a preference of the owner and multi-dimensional route features of each route, to obtain respective route scores of the plurality of routes, and the plurality of routes are sorted in descending order of the route scores to obtain a route sequence. The terminal extracts first n routes in the route sequence, n being a preset quantity, and uses each extracted route as an initial route. The multi-dimensional route features are features reflecting a plurality of dimensions of road attributes. For example, the multi-dimensional route features may include a duration, a route length, a quantity of traffic lights passed, and the like. The terminal may sort a plurality of routes through a pre-trained sorting-recommendation model, and extract a preset quantity of initial routes from the route sequence. The sorting-recommendation model is a machine learning model that has sorting and recommendation capabilities through sample learning.

Further, for each of the at least one initial route, the terminal may generate a navigation route corresponding to the initial route based on driving energy replenishment location data obtained in advance.

In the foregoing embodiment, because the plurality of routes are scored based on information such as a duration, a route length, and a quantity of traffic lights passed, a route with a higher score may have a shorter route length, a shorter duration, or a smaller quantity of traffic lights passed. Because a route with a higher score is selected as an initial route, the initial route is a route with a shorter route length, a route with a shorter duration, or a route with a smaller quantity of traffic lights passed in a plurality of routes, for example, the initial route is a better route in the plurality of routes, a better navigation route can be subsequently generated based on the better initial route.

In some embodiments, the terminal may obtain road attribute information of the initial route and obtain a remaining driving energy amount of the target vehicle, and generate a navigation route of the initial route when determining, based on the road attribute information and the remaining driving energy amount, that the target vehicle meets an on-route driving energy replenishment condition of the initial route. For example, the road attribute information may be a route length of the initial route. When it is determined that a route length that the target vehicle can travel based on the remaining driving energy amount is less than the route length of the initial route, the target vehicle is to perform driving energy replenishment on route if traveling along the initial route. In this case, it may be determined that the target vehicle meets the on-route driving energy replenishment condition of the initial route.

Further, when it is determined, based on road attribute information of an initially planned route and the remaining driving energy amount, that the target vehicle can travel from the start location to the end location based on the remaining driving energy amount, it is determined that the target vehicle does not meet an on-route driving energy replenishment condition of the initial planned route. In this case, the terminal directly uses the initial route as the navigation route. For example, if the driving energy is electric energy, when the terminal determines that the target vehicle can travel 500 kilometers based on a remaining power amount, and a route length of the initially planned route is 100 kilometers, the terminal may directly use the initially planned route as a navigation route without further generating a navigation route including a charging station label. For each of the at least one initial route, a corresponding navigation route can be determined in the foregoing manner.

In some embodiments, the road attribute information includes not only the route length, but also a traveling duration. The terminal may obtain a preset energy consumption model of the target vehicle. The energy consumption model is a model describing energy consumed by the target vehicle when the target vehicle travels a distance at different speeds per hour. For example, the energy consumption model may be a model recording power consumed per 100 kilometers at different speeds per hour. When obtaining the road attribute information of the initial route, the terminal may divide the route length in the road attribute information by the traveling duration in the road attribute information to obtain an average speed per hour, then determine, based on the average speed per hour and the energy consumption model, an amount of energy that the target vehicle may consume when the target vehicle travels along the initial route, and when the amount of energy is greater than the remaining driving energy amount of the target vehicle, determine that the target vehicle meets the on-route driving energy replenishment condition of the initial route. If the amount of energy is less than the remaining driving energy amount of the target vehicle, the terminal determines that the target vehicle does not meet the on-route driving energy replenishment condition of the initial route.

In the foregoing embodiment, when the on-route driving energy replenishment condition is not met, the initial route is directly used as the navigation route, thereby reducing resources, such as a computer, consumed when the navigation route is generated based on the initial route. When the on-route driving energy replenishment condition is met, a navigation route that includes an energy replenishment location label and that corresponds to the initial route is generated, so that the owner can be prompted, based on the energy replenishment location label, of a driving energy replenishment location to which the owner is to drive, thereby greatly improving the user experience.

In some embodiments, when it is determined, based on the road attribute information of the initial route and the remaining driving energy amount, that the target vehicle meets the on-route driving energy replenishment condition of the initial route, the generating a navigation route corresponding to the initial route includes: determining, for each of the at least one initial route, a plurality of target location points on the initial route, each of the target location points being one location point on the initial route; and sifting a plurality of candidate driving energy replenishment locations from the driving energy replenishment location data based on the plurality of target location points on the initial route; sifting at least one target driving energy replenishment location for energy replenishment succession from the candidate driving energy replenishment locations; and generating the navigation route corresponding to the initial route based on the start location to which the start point label points, the end location to which the end point label points, and the at least one target driving energy replenishment location.

When it is determined that the target vehicle is to perform on-route driving energy replenishment in a process of traveling along the initial route, the terminal may obtain a plurality of target location points on the initial route. The plurality of target location points are location points extracted from the initial route. For example, the route may be considered as a location point sequence including a series of location points, and the target location points may be location points extracted from the initial route at intervals. The location point may be a coordinate pair including a longitude and a latitude.

Further, the terminal may obtain driving energy replenishment location data. The driving energy replenishment location data is data recording all driving energy replenishment locations within a target region including the start location and the end location. For example, when the owner is to drive from Province A to Province B, the driving energy replenishment location data may be data recording all driving energy replenishment locations in Province A, Province B, and provinces between Province A and Province B. When obtaining the driving energy replenishment location data, the terminal may sift a plurality of candidate driving energy replenishment locations from the driving energy replenishment location data based on the plurality of target location points on the initial route. For example, candidate driving energy replenishment locations whose distances from the target location points meet a short-distance condition may be sifted from the driving energy replenishment location data. When a plurality of candidate driving energy replenishment locations are obtained, the terminal may sift at least one target driving energy replenishment location for energy replenishment from the plurality of candidate driving energy replenishment locations, for example, sift at least one target driving energy replenishment location corresponding to the initial route from the plurality of candidate driving energy replenishment locations, and perform route re-planning by using each of the at least one target driving energy replenishment location corresponding to the initial route as a waypoint, to generate a navigation route corresponding to the initial route.

In the foregoing embodiment, the candidate driving energy replenishment locations are sifted first, so that a quantity of the sifted target driving energy replenishment locations can be reduced, thereby reducing a computing amount of sifting the target driving energy replenishment locations, and further saving computing energy consumed for sifting the target driving energy replenishment locations.

In some embodiments, the displaying an energy replenishment location label at a waypoint on the target navigation route includes: displaying the navigation route corresponding to the initial route; and displaying, when the navigation route corresponding to the initial route is the target navigation route, one or more energy replenishment location labels respectively corresponding to the at least one target driving energy replenishment location on the navigation route corresponding to the initial route.

When a navigation route corresponding to the initial route is generated, the terminal may display the navigation route, and display a location label sequence on the navigation route. The terminal may display a location label sequence when the navigation route is a recommended navigation route or a switched-to navigation route to which a navigation route switching operation points. The location label sequence includes a start point label, one or more energy replenishment location labels respectively corresponding to the at least one target driving energy replenishment location, and an end point label. The at least one target driving energy replenishment location is at least one target driving energy replenishment location corresponding to the initial route. Different initial routes correspond to different location groups, each location group including at least one target driving energy replenishment location. The energy replenishment location label corresponding to the target driving energy replenishment location is a label displayed at a position corresponding to the target driving energy replenishment location on the corresponding navigation route.

In some embodiments, the terminal directly uses a plurality of sifted candidate driving energy replenishment locations as target driving energy replenishment locations. When a quantity of the plurality of candidate driving energy replenishment locations is greater than a preset quantity threshold, the terminal determines a first route length that the target vehicle can travel based on the remaining driving energy amount, determines a second route length that the target vehicle can travel based on driving energy of the storage capacity, and divides the initial route based on the first route length and the second route length to obtain a plurality of sections, so that a length of a first section is a first route length, and lengths of subsequent sections are all second route lengths. For each of the plurality of sections, the terminal determines candidate driving energy replenishment locations whose distances from the section are less than or equal to a preset distance threshold, and uses any one of the determined candidate driving energy replenishment locations as a target driving energy replenishment location. In this way, when the owner drives on each of the plurality of sections, there is a corresponding driving energy replenishment location for driving energy replenishment. In some embodiments, the determining a plurality of target location points on the initial route includes: determining a plurality of location points on the initial route, and rarefying the plurality of location points to obtain a plurality of target location points. The sifting a plurality of candidate driving energy replenishment locations from the driving energy replenishment location data based on the plurality of target location points on the initial route includes: for each target location point in the plurality of target location points, sifting, from the driving energy replenishment location data, candidate driving energy replenishment locations whose distances from the target location point meet a short-distance condition.

The initial route may be converted into a series of coordinate point strings, each coordinate point in the coordinate point string being a location point. The terminal may rarefy the plurality of location points to obtain a plurality of target location points. For example, a quantity of to-be-extracted target location points may be determined in advance, and then the route length of the initial route is divided by the quantity of the to-be-extracted target location points to obtain an extraction interval distance, so that the terminal sequentially extracts target location points from the plurality of location points based on the extraction interval distance. For example, when the extraction interval distance is 10 kilometers, the terminal may extract one target location point every 10 kilometers. The extraction interval distance may be preset, so that the terminal may sequentially extract the target location points from the plurality of location points directly based on the preset extraction interval distance.

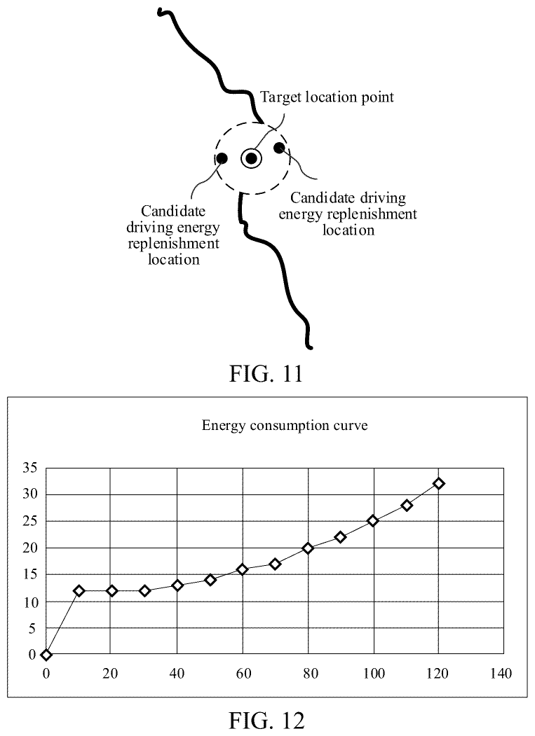

Further, when a plurality of target location points are extracted, for each target location point in the plurality of target location points, the terminal can sift, from the driving energy replenishment location data, candidate driving energy replenishment locations whose distances from the target location point meet a short-distance condition. For example, referring to FIG. 11, for a target location point A, a preset length may be obtained, a circle may be drawn with the target location point A as a center of a circle and the preset length as a radius, and energy replenishment locations within the circle are used as candidate driving energy replenishment locations whose distances from the target location point meet a short-distance condition. FIG. 11 is a schematic diagram of determining candidate driving energy replenishment locations according to some embodiments.

In some embodiments, the candidate driving energy replenishment locations whose distances from the target location point meet the short-distance condition are referred to as candidate driving energy replenishment locations corresponding to the target location point. When a plurality of candidate driving energy replenishment locations corresponding to the target location point are obtained, some of the plurality of candidate driving energy replenishment locations may be further removed based on a pre-trained location sifting model. For example, the location sifting model may sort the plurality of candidate driving energy replenishment locations based on attribute information of the candidate driving energy replenishment locations, and remove some of the plurality of candidate driving energy replenishment locations based on a sorting result. The attribute information of the candidate driving energy replenishment locations may include popularity, quantities of charging piles, distances from the corresponding target location point, and the like of the candidate driving energy replenishment locations. Therefore, the location sifting model may score each candidate driving energy replenishment location based on the attribute information of the candidate driving energy replenishment locations, and remove candidate driving energy replenishment locations with scores less than a preset score threshold, to obtain candidate driving energy replenishment locations.

In the foregoing embodiment, because the candidate driving energy replenishment location is a location whose distance from the corresponding target location point meets the short-distance condition, the owner can drive to the candidate driving energy replenishment location for driving energy replenishment without performing a large deviation, thereby reducing energy waste caused by a large deviation.

In some embodiments, the vehicle has a storage capacity. The sifting at least one target driving energy replenishment location for energy replenishment succession from the candidate driving energy replenishment locations includes: sorting the candidate driving energy replenishment locations in ascending order based on distances from the start location to which the start point label points, to obtain an initial sequence; adding the start location to a head of the initial sequence, and adding the end location to which the end point label points to a tail of the initial sequence, to obtain a location sequence; obtaining an energy consumption model of the vehicle, and determining, based on the energy consumption model, estimated energy consumption amounts respectively corresponding to pairs of locations in the location sequence; and performing at least one round of target driving energy replenishment location shifting based on at least one of the estimated energy consumption amounts respectively corresponding to the pairs of locations, the remaining driving energy amount, and the storage capacity, to obtain the at least one target driving energy replenishment location.

When obtaining the start location, the end location, and the plurality of candidate driving energy replenishment locations, the terminal may generate a location sequence including the start location, the end location, and the plurality of candidate driving energy replenishment locations. For example, the terminal may sort the plurality of candidate driving energy replenishment locations in ascending order based on distances from the start location, to obtain an initial sequence, add the start location to a head of the initial sequence, and add the end location to a tail of the initial sequence, to obtain a location sequence.

Further, the terminal obtains a pre-generated energy consumption model of the target vehicle. The energy consumption model is a model reflecting energy consumed by the target vehicle when the target vehicle travels a distance at different speeds per hour. For example, the energy consumption model may record power that is to be consumed for the target vehicle to travel 100 kilometers at a speed of 10 to 80 km/h. When obtaining the energy consumption model of the target vehicle, the terminal may determine, based on the energy consumption model, estimated energy consumption amounts respectively corresponding to pairs of locations in the location sequence. For example, if the location sequence includes a start location, a candidate driving energy replenishment location 1, a candidate driving energy replenishment location 2, and an end location, the terminal may determine, based on the energy consumption model, an estimated energy consumption amount corresponding to the start location and the candidate driving energy replenishment location 1, an estimated energy consumption amount corresponding to the start location and the candidate driving energy replenishment location 2, an estimated energy consumption amount corresponding to the start location and the end location, an estimated energy consumption amount corresponding to the candidate driving energy replenishment location 1 and the candidate driving energy replenishment location 2, and so on. An estimated energy consumption amount corresponding to a pair of locations is an amount of energy that the target vehicle may consume on a section between the pair of locations. For example, when the driving energy is electric energy, the estimated energy consumption amount corresponding to the start location and the candidate driving energy replenishment location 2 is an amount of power that the target vehicle may consume when traveling from the start location to the candidate driving energy replenishment location 2.

Further, after determining the estimated energy consumption amounts respectively corresponding to the pairs of locations in the location sequence, the terminal may perform at least one round of target driving energy replenishment location determining based on at least one of the estimated energy consumption amounts respectively corresponding to the pairs of locations, the remaining driving energy amount, and the storage capacity until a preset stop condition is met, to obtain the at least one target driving energy replenishment location. The preset stop condition may be freely set.

In some embodiments, different vehicle models have different energy consumption models. When the energy is electric energy, an energy consumption model of a vehicle may be shown in Table 1:

TABLE 1
Energy consumption model table of a vehicle

| | Basic power | Additional power |
|---|---|---|
| Speed | consumption per 100 | consumption for seat |
| (KM/H) | kilometers (kWh) | heating (kWh/hour) |
| 0 | 0 | 0.01 |
| 10 | 13 | 0.01 |
| 20 | 12 | 0.01 |
| 30 | 13 | 0.01 |
| 40 | 13 | 0.01 |
| 50 | 14 | 0.01 |
| 60 | 16 | 0.01 |
| 70 | 17 | 0.01 |
| 80 | 20 | 0.01 |
| 90 | 22 | 0.01 |
| 100 | 24 | 0.01 |
| 110 | 28 | 0.01 |
| 120 | 32 | 0.01 |

In some embodiments, FIG. 12 is a schematic diagram of an energy consumption curve according to some embodiments. Referring to FIG. 12, a horizontal ordinate may be a speed, and a vertical ordinate may be an amount of power consumed per 100 kilometers.

In the foregoing embodiment, because the energy consumption model is generated in advance, when a target driving energy replenishment location is to be determined, the target driving energy replenishment location may be quickly determined based on the energy consumption model, thereby improving efficiency of determining the target driving energy replenishment location. Because the energy consumption model includes energy consumption amounts per 100 kilometers corresponding to a plurality of speeds per hour, estimated energy consumption amounts respectively corresponding to pairs of locations in the location sequence can be accurately determined based on the energy consumption model, thereby improving accuracy of the target driving energy replenishment location determined based on the estimated energy consumption amounts respectively corresponding to the pairs of locations in the location sequence.

In some embodiments, the energy consumption model includes a plurality of energy consumption sub-models. The determining, based on the energy consumption model, estimated energy consumption amounts respectively corresponding to pairs of locations in the location sequence includes: predicting, for each pair of locations in the location sequence, an average speed per hour of the vehicle on a section between the pair of locations; sifting, from the plurality of energy consumption sub-models in the energy consumption model, a target energy consumption sub-model corresponding to the average speed per hour; and determining the estimated energy consumption amount corresponding to the pair of locations based on the target energy consumption sub-model and a length of the section between the pair of locations.

When the estimated energy consumption amounts respectively corresponding to the pairs of locations in the location sequence is to be determined, for each pair of locations in the location sequence, the terminal may estimate an average speed per hour of the target vehicle on a section between the pair of locations. For example, when the initial route is generated, a total travel duration of the initial route may be estimated, the route length of the initial route is divided by the total travel duration to obtain an average speed per hour of the initial route, and the average speed per hour of the initial route is used as an average speed per hour on a section between a pair of locations on the initial route. Further, the terminal sifts a target energy consumption sub-model corresponding to the average speed per hour from the energy consumption model. For example, referring to Table 1, when the average speed per hour on the section between the pair of locations is 60 KM/H, it may be determined that the target energy consumption sub-model is that power consumption per 100 kilometers is 16 kWh. When the target energy consumption sub-model is sifted, the terminal determines an estimated energy consumption amount corresponding to the pair of locations based on the target energy consumption sub-model and a length of the section between the pair of locations. For example, the terminal multiplies the target energy consumption sub-model by the length of the section between the pair of locations to obtain the estimated energy consumption amount corresponding to the pair of locations. For each pair of locations in the location sequence, a corresponding estimated energy consumption amount can be determined in the foregoing manner.

In some embodiments, the terminal may further estimate, based on a road condition of the section between the pair of locations, an average speed per hour of the target vehicle on the section between the pair of locations. The road condition may be information representing a condition of a road. For example, the road condition may be a degree of road congestion, density of traffic lights on the road, a minimum speed limit on the road, or a maximum speed limit on the road. The average speed per hour of the section is estimated by integrating road conditions in a plurality of dimensions, so that accuracy of the determined average speed per hour can be improved.

In the foregoing embodiment, by estimating an average speed per hour of the target vehicle on the section between the pair of locations, a corresponding target energy consumption sub-model can be sifted from the energy consumption model based on the average speed per hour, so that an estimated energy consumption amount corresponding to the pair of locations is accurately determined based on the sifted target energy consumption sub-model.

In some embodiments, the performing at least one round of target driving energy replenishment location shifting based on at least one of the estimated energy consumption amounts respectively corresponding to the pairs of locations, the remaining driving energy amount, and the storage capacity, to obtain the at least one target driving energy replenishment location, includes: entering a current round of target driving energy replenishment location sifting, and determining a current location in the location sequence, when the current round is the first round, the current location being the start location, and when the current round is not the first round, the current location being a target driving energy replenishment location sifted in a previous round; sifting, with the current location as the start location, a target driving energy replenishment location from the plurality of candidate driving energy replenishment locations based on at least one of the estimated energy consumption amounts respectively corresponding to the pairs of locations, the remaining driving energy amount, and the storage capacity; and entering a next round of target driving energy replenishment location sifting, returning, with the sifted target driving energy replenishment location as a new current location, to the current location as the start location, and continuously performing the operation of sifting a target driving energy replenishment location from the plurality of candidate driving energy replenishment locations based on at least one of the estimated energy consumption amounts respectively corresponding to the pairs of locations, the remaining driving energy amount, and the storage capacity until a preset stop condition is met.

When the first round of target driving energy replenishment location sifting is performed, the terminal may use the start location in the location sequence as the current location, sift, with the current location as a start location, a candidate driving energy replenishment location farthest reachable by the target vehicle based on the remaining driving energy amount from the location sequence based on the estimated energy consumption amounts respectively corresponding to the pairs of locations and the remaining driving energy amount, and use the farthest reachable candidate driving energy replenishment location as a target driving energy replenishment location sifted in the first round. Further, using the target driving energy replenishment location sifted in the first round as a new current location, the terminal enters a second round of target driving energy replenishment location sifting, and sifts, with the current location as a start location, a candidate driving energy replenishment location farthest reachable by the target vehicle based on the storage capacity from the location sequence based on the estimated energy consumption amounts respectively corresponding to the pairs of locations and the storage capacity, and uses the farthest reachable candidate driving energy replenishment location as a target driving energy replenishment location sifted in the second round. Using the target driving energy replenishment location sifted in the second round as a new current location, the terminal sifts, with the current location as a start location, a candidate driving energy replenishment location farthest reachable by the target vehicle based on the storage capacity from the location sequence based on the estimated energy consumption amounts respectively corresponding to the pairs of locations and the storage capacity, and uses the farthest reachable candidate driving energy replenishment location as a target driving energy replenishment location sifted in a third round. This process is repeated in sequence until a preset stop condition is met. Energy replenishment location labels corresponding to the target driving energy replenishment locations sifted until a stop condition is met form location labels for succession.

In some embodiments, the preset stop condition includes at least a first stop sub-condition and a second stop sub-condition. The first stop sub-condition is that an estimated energy consumption amount between the current location and a subsequent location is greater than the preset multiple of the storage capacity, the subsequent location being a location located behind the current location and adjacent to the current location in the location sequence. The second stop sub-condition is that a next location adjacent to the current location in the location sequence is the end location. For example, the location sequence includes a start location, a candidate driving energy replenishment location 1, a candidate driving energy replenishment location 2, a candidate driving energy replenishment location 3, and an end location. When the current location is the candidate driving energy replenishment location 2, and it is determined that the target vehicle cannot travel from the candidate driving energy replenishment location 2 to the candidate driving energy replenishment location 3 based on the storage capacity, it is determined that a next location closest to the current location in the location sequence is unreachable, and in this case, the first stop sub-condition is met. For another example, when the current location is the candidate driving energy replenishment location 3, and a next location closest to the candidate driving energy replenishment location 3 is the end location, it is determined that the second stop sub-condition is met.

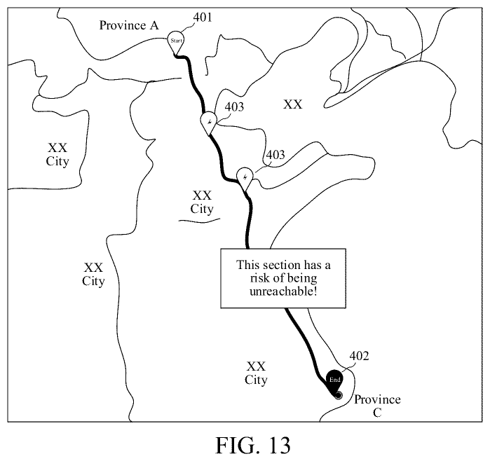

In some embodiments, when it is determined that the first stop sub-condition is met, and one or more energy replenishment location labels respectively corresponding to at least one target driving energy replenishment location are displayed on the navigation route corresponding to the initial route, prompt information may be displayed to prompt that a subsequent section has risk of being unreachable. For example, referring to FIG. 10, when the owner is to drive the vehicle from Province A to Province C, if a charging station only exists between Province A and Province B, and no charging station is set up between Province B and Province C, in a process of determining a target charging station, because no charging station is set up between Province B and Province C, a charging station to which the target vehicle can travel based on the battery capacity cannot be found on a section between Province B and Province C. In this case, the first stop sub-condition is met. Therefore, when the navigation route is displayed, a reachable target charging station can be displayed on a section of the navigation route between Province A and Province B, and a prompt of a risk of being unreachable is provided on the section between Province B and Province C, to provide a risk prompt to the owner based on the prompt of the risk of being unreachable, thereby greatly improving the user experience. FIG. 13 is a schematic diagram of prompting a risk of being unreachable according to some embodiments.

In some embodiments, when it is determined that the first stop sub-condition is met, the terminal may further perform a plurality of rounds of supplementary sifting processes. The plurality of rounds of supplementary sifting processes include: in a first supplementary sifting round, sifting, based on estimated energy consumption amounts respectively corresponding to pairs of locations and the storage capacity, a candidate driving energy replenishment location farthest reachable by the target vehicle from a plurality of candidate driving energy replenishment locations by using the end location as a current location and the current location as the start location, and using the candidate driving energy replenishment location as a target driving energy replenishment location; and entering a supplementary sifting round by using the target driving energy replenishment location as a new current location, returning to the operation of sifting, based on estimated energy consumption amounts respectively corresponding to pairs of locations and the storage capacity, a candidate driving energy replenishment location farthest reachable by the target vehicle from a plurality of candidate driving energy replenishment locations by using the current location as the start location to continuously perform the operation until a stop condition for supplementary sifting is met, for example, until a next location closest to the current location is unreachable. In this way, a plurality of target driving energy replenishment locations for energy succession starting from the start location can be obtained, and a plurality of target driving energy replenishment locations for energy succession starting from the end point can be obtained.

In the foregoing embodiment, a plurality of rounds of target driving energy replenishment location sifting are performed, so that target driving energy replenishment locations can be completely sifted.

In some embodiments, the estimated energy consumption amounts respectively corresponding to pairs of locations in the location sequence are included in an estimated energy consumption amount matrix. The estimated energy consumption amount matrix includes matrix rows respectively corresponding to all locations in the location sequence. For each matrix row in the estimated energy consumption amount matrix, the matrix row includes estimated energy consumption amounts respectively corresponding to a plurality of location groups, the plurality of location groups including location groups formed by a location corresponding to the matrix row and all locations in the location sequence. The sifting, with the current location as the start location, a target driving energy replenishment location from the plurality of candidate driving energy replenishment locations based on at least one of the estimated energy consumption amounts respectively corresponding to the pairs of locations, the remaining driving energy amount, and the storage capacity includes: when the current location is the start location, sifting, based on the remaining driving energy amount, a first target estimated energy consumption amount from a plurality of estimated energy consumption amounts included in a first matrix row, the first matrix row being a matrix row corresponding to the start location in the estimated energy consumption amount matrix, the first target estimated energy consumption amount being less than the remaining driving energy amount, and a subsequent estimated energy consumption amount located behind the first target estimated energy consumption amount in the matrix row corresponding to the start location being greater than or equal to the remaining driving energy amount; and using a location other than the start location in the location group corresponding to the first target estimated energy consumption amount as the target driving energy replenishment location for energy replenishment succession.

The estimated energy consumption amounts respectively corresponding to the pairs of locations in the location sequence is recorded in a form of an estimated energy consumption amount matrix. For example, an estimated energy consumption amount matrix K may be as follows:

$$K = [ \begin{matrix} & S & P 1 & P 2 & … & E \\ S & 0 & 10 & 15 & … & 150 \\ P 1 & - 10 & 0 & 5 & … & 130 \\ P 2 & & & & … & \\ … & & … & … & … & … \\ E & & … & … & … & 0\end{matrix} ]$$

where K is an M*M matrix, M being a quantity of locations included in the location sequence plus 1. S represents a start location, E represents an end location, P1 represents a candidate driving energy replenishment location closest to the start location in the location sequence, and P2 represents a candidate driving energy replenishment location second closest to the start location in the location sequence. {S, P1, P2, . . . , E} in the estimated energy consumption amount matrix K is a location sequence. Therefore, the estimated energy consumption amount matrix includes matrix rows respectively corresponding to all locations in the location sequence, each matrix row including estimated energy consumption amounts respectively corresponding to a plurality of location groups.

The location group is the foregoing two locations. For each matrix row in the estimated energy consumption amount matrix, the matrix row includes amounts of energy that may be consumed to respectively travel to all locations in the location sequence by using a location corresponding to the matrix row as a start location. For example, for a matrix row corresponding to the start location, the matrix row corresponding to the start location is referred to as a first matrix row. The first matrix row includes estimated energy consumption amounts respectively corresponding to location groups each formed by the start location and each location in the location sequence. For example, in a case that a matrix row corresponding to the start location is {0, 10, . . . , 150}, 0 represents that an estimated energy consumption amount corresponding to a location group formed by the start location and the start location is 0. In other words, 0 represents that an amount of energy that the target vehicle is to consume is 0 when the target vehicle travels from the start location to the start location. 10 represents that an estimated energy consumption amount corresponding to a location group formed by the start location and the candidate driving energy replenishment location P1 is 10. In other words, 10 represents that an amount of energy that the target vehicle is to consume is 10 when the target vehicle travels from the start location to the candidate driving energy replenishment location P1.

Further, when the current location is the start location, the terminal may use the start location as a start point, determine, in the location sequence, a candidate driving energy replenishment location farthest reachable by the target vehicle based on the remaining driving energy amount, and use the candidate driving energy replenishment location as the target driving energy replenishment location. When a candidate driving energy replenishment location farthest reachable by the target vehicle based on the remaining driving energy amount is to be determined in the location sequence, the terminal sifts, based on the remaining driving energy amount, a first target estimated energy consumption amount from a matrix row corresponding to the start point in the estimated energy consumption amount matrix, the first target estimated energy consumption amount being less than the remaining driving energy amount, and a subsequent estimated energy consumption amount located behind the first target estimated energy consumption amount in the matrix row corresponding to the start location being greater than or equal to the remaining driving energy amount. For example, when the remaining driving energy amount is 11, in a case that the matrix row corresponding to the start location is {0, 10, 15, . . . , 150}, it may be determined that 10 in the matrix row corresponding to the start location is the first target estimated energy consumption amount. An estimated energy consumption amount behind 10 is referred to as a subsequent estimated energy consumption amount. Because each matrix element in the matrix row is an estimated energy consumption amount corresponding to one location group, the terminal may determine a location group corresponding to the first target estimated energy consumption amount, and use a location other than the start location in the location group as a candidate driving energy replenishment location farthest reachable by the target vehicle based on the remaining driving energy amount. For example, when the first target estimated energy consumption amount is 10 in a matrix row {0, 10, 15, . . . , 150}, it may be determined that a location group corresponding to 10 is (the start location, the candidate driving energy replenishment location P1). In this case, the candidate driving energy replenishment location P1 is used as a target driving energy replenishment location sifted in the first round.

In the foregoing embodiment, because the sifted first target estimated energy consumption amount is less than the remaining driving energy amount, and a subsequent estimated energy consumption amount located behind the first target estimated energy consumption amount in the first matrix row is greater than or equal to the remaining driving energy amount, the target driving energy replenishment location corresponding to the first target estimated energy consumption amount is a farthest driving energy replenishment location to which the owner can travel based on the remaining driving energy amount. Because the farthest reachable location is used as the target driving energy replenishment location, a quantity of energy replenishment location labels displayed on the navigation route can be reduced, thereby reducing display resources consumed when an energy replenishment location label is displayed.

In some embodiments, the method further includes: when the current location is not the start location, sifting, based on the storage capacity, a second target estimated energy consumption amount from a plurality of estimated energy consumption amounts included in a second matrix row, the second matrix row being a matrix row corresponding to the current location in the estimated energy consumption amount matrix, the second target estimated energy consumption amount being less than a preset multiple of the storage capacity, and a subsequent estimated energy consumption amount located behind the second target estimated energy consumption amount in the second matrix row being greater than or equal to the preset multiple of the storage capacity; and using a location other than the current location in the location group corresponding to the second target estimated energy consumption amount as the target driving energy replenishment location for energy replenishment succession.

When the current location is not the start location, for example, in the remaining rounds other than the first round, the terminal may sift, based on the storage capacity, a second target estimated energy consumption amount from a matrix row corresponding to the current location. For the convenience of description, when the current location is not the start location, the matrix row corresponding to the current location is referred to as a second matrix row. The second target estimated energy consumption amount is less than or equal to a preset multiple of the storage capacity, and a subsequent estimated energy consumption amount located behind the target estimated energy consumption amount in a matrix row corresponding to the current location is greater than the preset multiple of the storage capacity. For example, when the current location is the candidate driving energy replenishment location P1, the storage capacity is 50, the preset multiple is 0.8, and a matrix row corresponding to the candidate driving energy replenishment location P1 is {−10, 0, 5, 37, 70, . . . , 130}, because the target vehicle can perform driving energy replenishment at the candidate driving energy replenishment location P1, a second target estimated energy consumption amount sifted by the terminal from the corresponding matrix row is 37. Because a location group corresponding to 37 is (the candidate driving energy replenishment location P1, the candidate driving energy replenishment location P3), the terminal uses the candidate driving energy replenishment location P3 as a target driving energy replenishment location sifted in the current round. The location also represents a farthest location to which the target vehicle can travel based on the preset multiple of the storage capacity by using the candidate driving energy replenishment location P1 as a start location. The preset multiple may be freely set. For example, when the owner expects that 10% power remains after traveling from the current charging station to the next charging station, 0.9 may be inputted into a preset multiple input box 703 in FIG. 7.

In the foregoing embodiment, because the sifted second target estimated energy consumption amount is less than or equal to the preset multiple of the storage capacity, and a subsequent estimated energy consumption amount located behind the second target estimated energy consumption amount in the second matrix row is greater than the preset multiple of the storage capacity, the target driving energy replenishment location corresponding to the second target estimated energy consumption amount is a farthest driving energy replenishment location to which the owner can travel based on the preset multiple of the storage capacity. Because the farthest reachable location is used as the target driving energy replenishment location, a quantity of energy replenishment location labels displayed on the navigation route can be reduced, thereby reducing display resources consumed when an energy replenishment location label is displayed.

In some embodiments, after the plurality of candidate charging stations corresponding to the initial route are retrieved, an M*M matrix may be formed by adding the start location and the end location of the route. The terminal calculates estimated energy consumption amounts between pairs by using a fast matrix route planning method with reference to the energy consumption model mentioned above, to obtain an estimated energy consumption amount matrix. The start location of the route is assigned with a current remaining driving energy of the target vehicle for calculating a farthest reachable candidate driving energy replenishment location V. The candidate driving energy replenishment location V is used as a start location, and the energy amount is assigned with a preset multiple of a storage capacity of the vehicle, for performing a next round of succession. By analogy, a succession connection planning is finally completed. If succession cannot be performed midway, a target driving energy replenishment location at which succession has been performed previously is retained. Using Province A to Province C as an example, target driving energy replenishment locations selected after succession is performed are distributed as shown in FIG. 4, and it can be clearly seen that the target driving energy replenishment locations are distributed relatively uniform, and are reachable pairwise based on remaining energy.

In some embodiments, the generating the navigation route corresponding to the initial route based on the start location to which the start point label points, the end location to which the end point label points, and the at least one target driving energy replenishment location includes: performing, based on the start location to which the start point label points and the end location to which the end point label points, route re-planning by using each of the at least one target driving energy replenishment location as the waypoint of the vehicle, to generate the navigation route corresponding to the initial route.

When obtaining at least one target driving energy replenishment location corresponding to the initial route, the terminal performs route re-planning by using each of the at least one target driving energy replenishment location as the waypoint of the target vehicle, to generate the navigation route corresponding to the initial route. The navigation route passes each of the at least one target driving energy replenishment location.

In some embodiments, the terminal may perform route re-planning based on a preset route planning function, so that the re-planned navigation route not only passes each of the at least one target driving energy replenishment location, but also can meet conditions such as a shorter distance and a shorter duration.

There is a problem of being unreachable caused by manual selection. In the conventional technology, when a user searches for a driving energy replenishment location in an electronic map application, the electronic map application may provide all driving energy replenishment locations, so that an owner can select, from the driving energy replenishment locations provided by the electronic map application, a driving energy replenishment location to drive to. However, because the owner cannot accurately learn of a distance that the vehicle continuously travels forward from a location of the vehicle, the selected driving energy replenishment location may be unreachable. In a long-distance scenario, because a plurality of driving energy replenishment locations may be selected, a probability of selecting an unreachable driving energy replenishment location in a large sample space is very high. In an actual application, once unreachability occurs, it means that there is a high cost. However, because a location (the target driving energy replenishment location) at which driving energy replenishment may be performed on route can be automatically determined, and the owner may not perform manual selection, the efficiency of determining the target driving energy replenishment location is improved. Because the target driving energy replenishment location is reachable, a probability that the target driving energy replenishment location is unreachable during traveling is reduced.

There is a problem of repeating selection after a deviation: Due to superimposition of a plurality of factors, the owner may deviate once or even a plurality of times during traveling. After a deviation occurs, based on an existing technical solution, each time the owner manually re-searches for and re-selects a driving energy replenishment location, there is a problem of repeating selection a plurality of times. However, after a deviation, a target driving energy replenishment location can still be automatically determined based on a deviated route. Therefore, there is no problem of repeating selection a plurality of times, thereby reducing resources consumed by repeating selection a plurality of times.

There is a problem of high costs of manual selection: During forward route planning, the owner pays a cost when making a selection from a list of candidate driving energy replenishment locations. During traveling, the owner may deviate or refresh a route for a plurality of reasons, for example, route planning may be performed again. This also means that the owner may re-select a proper driving energy replenishment location, but the owner is mainly driving, and re-selection may be a costly behavior. However, because the target driving energy replenishment location can be automatically determined, the owner can focus on driving, thereby improving driving safety.

There is a problem in a long-distance scenario: The owner may search for and select one or more driving energy replenishment locations. In a case that the owner cannot perceive and calculate a maximum distance that the vehicle can cruise from a location of the vehicle, in a large sample space, a probability that the selected driving energy replenishment location is unreachable is increased. However, because the target driving energy replenishment location is determined based on the remaining driving energy amount and the storage capacity, the determined target driving energy replenishment location is reachable.

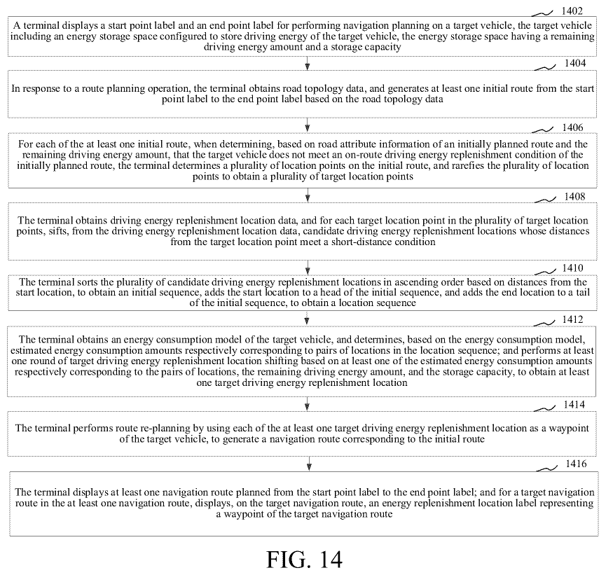

In some embodiments, referring to FIG. 14, FIG. 14 shows a method for displaying a navigation route according to some embodiments.

Operation 1402: A terminal displays a start point label and an end point label for performing navigation planning on a target vehicle, the target vehicle including an energy storage space configured to store driving energy of the target vehicle, the energy storage space having a remaining driving energy amount and a storage capacity.

Operation 1404: In response to a route planning operation, the terminal obtains road topology data, and generates at least one initial route from the start point label to the end point label based on the road topology data.

Operation 1406: For each of the at least one initial route, determine a plurality of location points on the initial route, and rarefy the plurality of location points to obtain a plurality of target location points.

Operation 1408: The terminal obtains driving energy replenishment location data, and for each target location point in the plurality of target location points, sifts, from the driving energy replenishment location data, candidate driving energy replenishment locations whose distances from the target location point meet a short-distance condition.

Operation 1410: The terminal sorts the candidate driving energy replenishment locations in ascending order based on distances from the start location to which the start point label points, to obtain an initial sequence; and adds the start location to a head of the initial sequence, and adds the end location to which the end point label points to a tail of the initial sequence, to obtain a location sequence.

Operation 1412: The terminal obtains an energy consumption model of the target vehicle, and determines, based on the energy consumption model, estimated energy consumption amounts respectively corresponding to pairs of locations in the location sequence; and performs at least one round of target driving energy replenishment location shifting based on at least one of the estimated energy consumption amounts respectively corresponding to the pairs of locations, the remaining driving energy amount, and the storage capacity, to obtain at least one target driving energy replenishment location.

Operation 1414: The terminal performs route re-planning by using each of the at least one target driving energy replenishment location as a waypoint of the target vehicle, to generate a navigation route corresponding to the initial route.

Operation 1416: The terminal displays at least one navigation route planned from the start point label to the end point label; and for a target navigation route in the at least one navigation route, displays, on the target navigation route, an energy replenishment location label representing a waypoint of the target navigation route.

Although the steps in the flowcharts involved in the foregoing embodiments are displayed sequentially according to instructions of arrows, these steps are not necessarily performed sequentially according to a sequence instructed by the arrows. The steps are performed without any strict sequence limit, and may be performed in other sequences. At least some of the steps in the flowcharts involved in the foregoing embodiments may include a plurality of steps or a plurality of stages. These steps or stages are not necessarily performed and completed at the same moment, and may be performed at different moments. Besides, the steps or stages may not be necessarily performed sequentially, and may be performed in turn or alternately with other steps or at least a part of steps or stages of other steps.

The disclosure further provides an application scenario. The foregoing method for displaying a navigation route is applied to the application scenario. The method for displaying a navigation route is applied to the application scenario as follows:

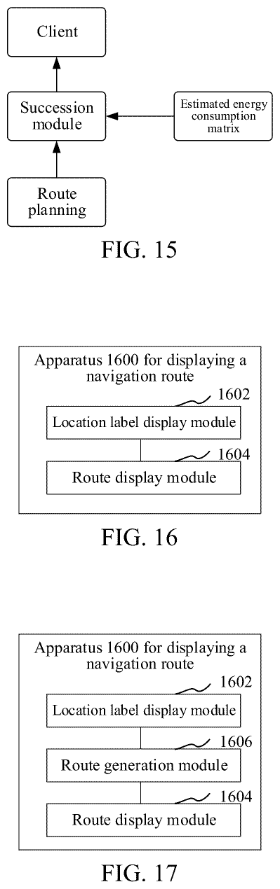

When an owner is to drive a new energy vehicle from Province A to Province C, the owner may input Province A and Province C into a client of an electronic map application, to cause the electronic map application to perform initial route planning, and determine, based on an estimated energy consumption amount matrix and a succession module, a target charging station for power replenishment. The electronic map application performs secondary route planning based on the determined target charging station, to obtain and display a navigation route from Province A to Province C. A location label of the target charging station is displayed on the navigation route. Each target charging station is a waypoint of the navigation route, and each target charging station is a reachable charging station. FIG. 15 is a schematic diagram of a framework of displaying a navigation route according to some embodiments.

The disclosure further provides an application scenario. The foregoing method for displaying a navigation route is applied to the application scenario. The method for displaying a navigation route is applied to the application scenario as follows:

When an owner is to drive a vehicle from Province A to Province C, the owner may input Province A and Province C into an APP end of an electronic map application, to cause the electronic map application to perform initial route planning, and determine, based on an estimated energy consumption amount matrix and a succession module, a gas station for power replenishment. The electronic map application performs secondary route planning based on the determined target gas station, to obtain and display a navigation route from Province A to Province C. A location label of the target gas station is displayed on the navigation route. Each target gas station is a waypoint of the navigation route, and each target gas station is a reachable gas station.

The foregoing application scenarios are merely exemplary descriptions. The method for displaying a navigation route provided in some embodiments is not limited to being applied to the foregoing scenarios.

Some embodiments further provide an apparatus for displaying a navigation route, configured to implement the foregoing involved method for displaying a navigation route. The solution to the problem provided by the apparatus is similar to the solution described in the foregoing method. Therefore, reference may be made to the method for displaying a navigation route above.

In some embodiments, as shown in FIG. 16, an apparatus 1600 for displaying a navigation route is provided, including: a location label display module 1602 and a route display module 1604.

The location label display module 1602 is configured to display a start point label and an end point label for performing navigation planning on a target vehicle, the start point label being a label representing a start location of the navigation planning, and the end point label being a label representing an end location of the navigation planning.

The route display module 1604 is configured to display at least one navigation route planned from the start point label to the end point label; and display, for a target navigation route in the at least one navigation route, an energy replenishment location label on the target navigation route, the energy replenishment location label being a label representing a waypoint of the target navigation route, the waypoint represented by the energy replenishment location label being a driving energy replenishment location of the vehicle, and the target navigation route being one of the at least one navigation route.

In some embodiments, referring to FIG. 17, the location label display module 1602 is further configured to display a navigation map and a navigation trigger control in response to a navigation map display operation; and display the start point label and the end point label in the navigation map in response to a trigger operation on the navigation trigger control.

In some embodiments, the location label display module 1602 is further configured to display an initial page in response to the navigation map display operation, a start point input box, an end point input box, the navigation trigger control, and the navigation map being displayed in the initial page; in response to a first input operation on the start point input box, display, in the start point input box, the start location inputted through the first input operation; in response to a second input operation on the end point input box, display, in the end point input box, the end location inputted through the second input operation; and display, in response to the trigger operation on the navigation trigger control, the start point label corresponding to the start location and the end point label corresponding to the end location in the navigation map.

In some embodiments, the route display module 1604 is further configured to display vehicle information of the vehicle, the vehicle information including a remaining driving energy amount and a storage capacity of the vehicle, the storage capacity being a capacity of an energy storage space, the energy storage space being a space for storing driving energy of the vehicle; and display, in response to a confirmation operation on the vehicle information, the at least one navigation route planned from the start point label to the end point label.

In some embodiments, the route display module 1604 is further configured to display an information input page, and displaying, in response to a third input operation on the information input page, vehicle information inputted through the third input operation.

In some embodiments, for the target navigation route in the at least one navigation route, a location label sequence from the start point label to the end point label is displayed on the target navigation route. The location label sequence includes an energy replenishment location label located between the start point label and the end point label.

In some embodiments, in the location label sequence, an estimated energy consumption amount of a section between first two location labels is not greater than the remaining driving energy amount, and an estimated energy consumption amount of a section between any adjacent energy replenishment location labels is not greater than the storage capacity.

In some embodiments, the target navigation route is a recommended navigation route or a switched-to navigation route to which a navigation route switching operation points. The route display module 1604 is further configured to display the at least one navigation route planned from the start point label to the end point label, highlight the recommended navigation route in the at least one navigation route, and display the energy replenishment location label on the recommended navigation route; and in response to the navigation route switching operation, switch from highlighting the recommended navigation route to highlighting the switched-to navigation route to which the navigation route switching operation points, and switch from displaying the energy replenishment location label on the recommended navigation route to displaying an energy replenishment location label on the switched-to navigation route.

In some embodiments, the energy replenishment location label displayed on the recommended navigation route and the energy replenishment location label displayed on the switched-to navigation route are not completely the same.

In some embodiments, the route display module is further configured to display label information corresponding to each energy replenishment location label, the label information including at least one of a time spent for driving energy of the vehicle to be replenished to a preset target amount, a time spent for the vehicle to travel to the energy replenishment location to which the corresponding energy replenishment location label points, and a quantity of energy replenishment devices at the energy replenishment location to which the corresponding energy replenishment location label points.

In some embodiments, the apparatus 1600 for displaying a navigation route further includes a route generation module 1606, configured to obtain road topology data, and generating at least one initial route from the start point label to the end point label based on the road topology data; and obtain driving energy replenishment location data; and generating one or more navigation routes respectively corresponding to the at least one initial route based on the driving energy replenishment location data.

In some embodiments, the route generation module 1606 is further configured to: determine, for each of the at least one initial route, a plurality of target location points on the initial route, each of the target location points being one location point on the initial route; sift a plurality of candidate driving energy replenishment locations from the driving energy replenishment location data based on the plurality of target location points on the initial route; sift at least one target driving energy replenishment location for energy replenishment succession from the candidate driving energy replenishment locations; and generate a navigation route corresponding to the initial route based on the start location to which the start point label points, the end location to which the end point label points, and the at least one target driving energy replenishment location.

In some embodiments, the route display module 1604 is further configured to display the navigation route corresponding to the initial route; and display, when the navigation route corresponding to the initial route is the target navigation route, one or more energy replenishment location labels respectively corresponding to the at least one target driving energy replenishment location on the navigation route corresponding to the initial route.

In some embodiments, the route generation module 1606 is further configured to determine a plurality of location points on the initial route, and rarefy the plurality of location points to obtain a plurality of target location points; and for each target location point in the plurality of target location points, sift, from the driving energy replenishment location data, candidate driving energy replenishment locations whose distances from the target location point meet a short-distance condition.

In some embodiments, the vehicle has a storage capacity. The route generation module 1606 is further configured to sort the candidate driving energy replenishment locations in ascending order based on distances from the start location to which the start point label points, to obtain an initial sequence; add the start location to a head of the initial sequence, and add the end location to which the end point label points to a tail of the initial sequence, to obtain a location sequence; obtain an energy consumption model of the vehicle, and determine, based on the energy consumption model, estimated energy consumption amounts respectively corresponding to pairs of locations in the location sequence; and perform at least one round of target driving energy replenishment location shifting based on at least one of the estimated energy consumption amounts respectively corresponding to the pairs of locations, the remaining driving energy amount, and the storage capacity, to obtain the at least one target driving energy replenishment location.

In some embodiments, the energy consumption model includes a plurality of energy consumption sub-models. The route generation module 1606 is further configured to: predict, for each pair of locations in the location sequence, an average speed per hour of the vehicle on a section between the pair of locations; sift, from the plurality of energy consumption sub-models in the energy consumption model, a target energy consumption sub-model corresponding to the average speed per hour; and determine the estimated energy consumption amount corresponding to the pair of locations based on the target energy consumption sub-model and a length of the section between the pair of locations.

In some embodiments, the route generation module 1606 is further configured to enter a current round of target driving energy replenishment location sifting, and determine a current location in the location sequence, when the current round is the first round, the current location being the start location, and when the current round is not the first round, the current location being a target driving energy replenishment location sifted in a previous round; sift, with the current location as the start location, a target driving energy replenishment location from the plurality of candidate driving energy replenishment locations based on at least one of the estimated energy consumption amounts respectively corresponding to the pairs of locations, the remaining driving energy amount, and the storage capacity; enter a next round of target driving energy replenishment location sifting, return, with the sifted target driving energy replenishment location as a new current location, to the current location as the start location, and continuously perform the operation of sifting a target driving energy replenishment location from the plurality of candidate driving energy replenishment locations based on at least one of the estimated energy consumption amounts respectively corresponding to the pairs of locations, the remaining driving energy amount, and the storage capacity until a preset stop condition is met.

In some embodiments, the estimated energy consumption amounts respectively corresponding to pairs of locations in the location sequence are included in an estimated energy consumption amount matrix. The estimated energy consumption amount matrix includes matrix rows respectively corresponding to all locations in the location sequence. For each matrix row in the estimated energy consumption amount matrix, the matrix row includes estimated energy consumption amounts respectively corresponding to a plurality of location groups, the plurality of location groups including location groups formed by a location corresponding to the matrix row and all locations in the location sequence. The route generation module 1606 is further configured to: when the current location is not the start location, sift, based on the remaining driving energy amount, a first target estimated energy consumption amount from a plurality of estimated energy consumption amounts included in a first matrix row, the first matrix row being a matrix row corresponding to the start location in the estimated energy consumption amount matrix, the first target estimated energy consumption amount being less than the remaining driving energy amount, and a subsequent estimated energy consumption amount located behind the first target estimated energy consumption amount in the first matrix row being greater than or equal to the remaining driving energy amount; and use a location other than the start location in the location group corresponding to the first target estimated energy consumption amount as the target driving energy replenishment location for energy replenishment succession.

In some embodiments, the route generation module 1606 is further configured to: when the current location is not the start location, sift, based on the storage capacity, a second target estimated energy consumption amount from a plurality of estimated energy consumption amounts included in a second matrix row, the second matrix row being a matrix row corresponding to the current location in the estimated energy consumption amount matrix, the second target estimated energy consumption amount being less than a preset multiple of the storage capacity, and a subsequent estimated energy consumption amount located behind the second target estimated energy consumption amount in the second matrix row being greater than or equal to the preset multiple of the storage capacity; and use a location other than the current location in the location group corresponding to the second target estimated energy consumption amount as the target driving energy replenishment location for energy replenishment succession.

In some embodiments, the preset stop condition includes at least a first stop sub-condition and a second stop sub-condition. The first stop sub-condition is that an estimated energy consumption amount between the current location and a subsequent location is greater than the preset multiple of the storage capacity, the subsequent location being a location located behind the current location and adjacent to the current location in the location sequence. The second stop sub-condition is that a next location adjacent to the current location in the location sequence is the end location.

In some embodiments, the route generation module 1606 is further configured to perform based on the start location to which the start point label points and the end location to which the end point label points, route re-planning by using each of the at least one target driving energy replenishment location as the waypoint of the vehicle, to generate the navigation route corresponding to the initial route. The waypoint is a location that the route passes. For example, referring to FIG. 4, locations to which 405 and 406 in FIG. 4 point are waypoints of the target navigation route.

According to some embodiments, each module may exist respectively or be combined into one or more modules. Some modules may be further split into multiple smaller function subunits, thereby implementing the same operations without affecting the technical effects of some embodiments. The modules are divided based on logical functions. In actual applications, a function of one module may be realized by multiple modules, or functions of multiple modules may be realized by one module. In some embodiments, the apparatus may further include other modules. In actual applications, these functions may also be realized cooperatively by the other modules, and may be realized cooperatively by multiple modules.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

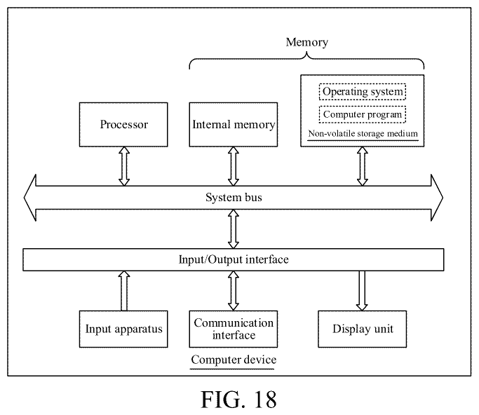

In some embodiments, a computer device is provided. The computer device may be a terminal, and an internal structure diagram thereof may be shown in FIG. 18. The computer device includes a processor, a memory, an input/output interface, a communication interface, a display unit, and an input apparatus. The processor, the memory, and the input/output interface are connected by a system bus, and the communication interface, the display unit, and the input apparatus are connected to the system bus by the input/output interface. The processor of the computer device is configured to provide computing and control capabilities. The memory of the computer device includes a non-volatile storage medium and an internal memory. The non-volatile storage medium stores an operating system and a computer program. The internal memory provides an environment for running of the operating system and the computer program in the non-volatile storage medium. The input/output interface of the computer device is configured to exchange information between the processor and an external device. The communication interface of the computer device is configured for wired or wireless communication with an external terminal. The wireless manner may be implemented through Wi-Fi, a mobile cellular network, near field communication (NFC), or other technologies. The computer program is executed by the processor to implement a method for displaying a navigation route. The display unit of the computer device is configured to form a visually visible picture, and may be a display screen, a projection apparatus, or a virtual reality imaging apparatus. The display screen of the computer device may be a liquid crystal display screen or an electronic ink display screen. The input apparatus of the computer device may be a touch layer covering the display screen, or may be a key, a trackball, or a touch pad disposed on a housing of the computer device, or may be an external keyboard, a touch pad, a mouse, or the like.

A person skilled in the art may understand that, the structure shown in FIG. 18 is only a block diagram of a part of a structure related to a solution of the disclosure and does not limit the computer device to which the solution is applied. The computer device may include more members than those in the drawings, or include a combination of some members, or include different member layouts.

In some embodiments, a computer device is provided, including a memory and a processor, the memory storing a computer program, the processor, when executing the computer program, implementing the operations in the foregoing method embodiments. In some embodiments, a computer-readable storage medium is provided, having a computer program stored therein. When executed by the processor, the computer program causes the processor to perform the steps in the foregoing method embodiments.

In some embodiments, a computer program product or a computer program is provided. The computer program product or the computer program includes computer instructions, and the computer instructions are stored in a computer-readable storage medium. The processor of the computer device reads the computer instructions from the computer-readable storage medium, and the processor executes the computer instructions, to cause the computer device to perform the steps in the method embodiments.

All the user information (including, but not limited to, user equipment information, personal information of users, and the like) and data (including, but not limited to, data for analysis, stored data, displayed data, and the like) are information and data authorized by the users or fully authorized by all parties. The collection, use, and processing of relevant data should comply with relevant laws, regulations, and standards of relevant countries and regions.

A person of ordinary skill in the art may understand that all or some of procedures of the method in the foregoing embodiments may be implemented by a computer program instructing relevant hardware. The computer program may be stored in a non-volatile computer-readable storage medium. When the computer program is executed, the procedures of the foregoing method embodiments may be implemented. Any reference to a memory, a database, or another medium used in some embodiments may include at least one of a non-volatile memory and a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric m random access memory (FRAM), a phase change memory (PCM), a graphene memory, and the like. The volatile memory may include a random access memory (RAM), an external cache, or the like. For the purpose of description instead of limitation, the RAM is available in a plurality of forms, such as a static RAM (SRAM) or a dynamic RAM (DRAM). The database involved in some embodiments may include at least one of a relational database and a non-relational database. The non-relational database may include a blockchain-based distributed database and the like, but is not limited thereto. The processor involved in some embodiments may be a general-purpose processor, a central processing unit, a graphics processing unit, a digital signal processor, a programmable logic device, a data processing logic device based on quantum computing, or the like, but is not limited thereto.

Technical features of the foregoing embodiments may be combined in different manners to form other embodiments.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A method for displaying a navigation route, performed by a user terminal, the method comprising:
displaying, for performing navigation planning with respect to a vehicle, a start point label indicating a start location of the navigation planning and an end point label indicating an end location of the navigation planning;
displaying at least one navigation route planned from the start point label to the end point label; and
displaying, for a target navigation route in the at least one navigation route, a first energy replenishment location label indicating a waypoint of the target navigation route, on the target navigation route, wherein the waypoint corresponds to a driving energy replenishment location for the vehicle.

2. The method according to claim 1, wherein the displaying the start point label and the end point label comprises:
displaying, in response to a navigation map display operation, a navigation map and a navigation trigger control; and
displaying, in response to a trigger operation on the navigation trigger control, the start point label and the end point label in the navigation map.

3. The method according to claim 2, wherein the displaying the navigation map comprises:
displaying, in response to the navigation map display operation, an initial page comprising a start point input box, an end point input box, the navigation trigger control, and the navigation map;
displaying in the start point input box, in response to a first input operation on the start point input box, the start location, wherein the start location is input via the first input operation; and
displaying in the end point input box, in response to a second input operation on the end point input box, the end location, wherein the end location is input via the second input operation, and
wherein the displaying the start point label and the end point label in the navigation map comprises:
displaying, in response to the trigger operation, the start point label and the end point label in the navigation map, wherein the start point label corresponds to the start location and the end point label corresponds to the end location.

4. The method according to claim 1, wherein the displaying the at least one navigation route comprises:
displaying vehicle information of the vehicle comprising a remaining driving energy amount and a storage capacity of the vehicle indicating a capacity of an energy storage space for storing driving energy of the vehicle; and
displaying, in response to a confirmation operation on the vehicle information, the at least one navigation route.

5. The method according to claim 4, wherein the displaying the vehicle information comprises:
displaying an information input page; and
displaying, in response to a third input operation on the information input page, the vehicle information, wherein the vehicle information is input via the third input operation.

6. The method according to claim 4, wherein, for the target navigation route, a location label sequence from the start point label to the end point label is displayed on the target navigation route, and
wherein the location label sequence comprises the first energy replenishment location label, and the first energy replenishment location label is located between the start point label and the end point label.

7. The method according to claim 6, wherein, in the location label sequence:
a first estimated energy consumption amount of a first section between the start point label and a next label is not greater than the remaining driving energy amount, and
a second estimated energy consumption amount of a second section between any adjacent energy replenishment location labels is not greater than the storage capacity.

8. The method according to claim 1, wherein the target navigation route is a recommended navigation route or a switched-to navigation route to which a navigation route switching operation points, and
wherein the displaying the at least one navigation route comprises:
displaying the at least one navigation route, highlighting the recommended navigation route in the at least one navigation route, and displaying the first energy replenishment location label on the recommended navigation route; and
in response to the navigation route switching operation:
switching from highlighting the recommended navigation route to highlighting the switched-to navigation route, and
switching from displaying the first energy replenishment location label on the recommended navigation route to displaying a second energy replenishment location label on the switched-to navigation route.

9. The method according to claim 8, wherein the first energy replenishment location label and the second energy replenishment location label are different energy replenishment location labels.

10. The method according to claim 1, wherein the method further comprises:
displaying label information corresponding to a plurality of energy replenishment location labels, the label information comprising at least one from among:
a time spent for driving energy of the vehicle to be replenished to a preset target amount,
a time spent for the vehicle to travel to a second energy replenishment location to which a corresponding energy replenishment location label points, and
a quantity of energy replenishment devices at the second energy replenishment location.

11. An apparatus for displaying a navigation route, comprising:
at least one memory configured to store computer program code; and
at least one processor configured to read the program code and operate as instructed by the program code, the program code comprising:
location label display code configured to cause at least one of the at least one processor to: display, for performing navigation planning with respect to a vehicle, a start point label indicating a start location of the navigation planning and an end point label indicating an end location of the navigation planning;
planned route code configured to cause at least one of the at least one processor to display at least one navigation route planned from the start point label to the end point label; and
energy location code configured to cause at least one of the at least one processor to display, for a target navigation route in the at least one navigation route, a first energy replenishment location label indicating a waypoint of the target navigation route, on the target navigation route, wherein the waypoint corresponds to a driving energy replenishment location for the vehicle.

12. The apparatus according to claim 11, wherein the planned route code further comprises map display code and navigation trigger code,
wherein the map display code is configured to cause at least one of the at least one processor to display, in response to a navigation map display operation, a navigation map and a navigation trigger control, and
wherein the navigation trigger code is configured to cause at least one of the at least one processor to display, in response to a trigger operation on the navigation trigger control, the start point label and the end point label in the navigation map.

13. The apparatus according to claim 12, wherein the map display code is further configured to cause at least one of the at least one processor to:
display, in response to the navigation map display operation, an initial page comprising a start point input box, an end point input box, the navigation trigger control, and the navigation map;
display in the start point input box, in response to a first input operation on the start point input box, the start location, wherein the start location is input via the first input operation; and
display in the end point input box, in response to a second input operation on the end point input box, the end location, wherein the end location is input via the second input operation, and
wherein the planned route code is configured to cause at least one of the at least one processor to display, in response to the trigger operation, the start point label and the end point label in the navigation map, wherein the start point label corresponds to the start location and the end point label corresponds to the end location.

14. The apparatus according to claim 11, wherein the planned route code further comprises vehicle information code and confirmation code,
wherein the vehicle information code is configured to cause at least one of the at least one processor to display vehicle information of the vehicle comprising a remaining driving energy amount and a storage capacity of the vehicle indicating a capacity of an energy storage space for storing driving energy of the vehicle, and
wherein the planned route code is configured to cause at least one of the at least one processor to display, in response to a confirmation operation on the vehicle information, the at least one navigation route.

15. The apparatus according to claim 14, wherein the vehicle information code is configured to cause at least one of the at least one processor to:
display an information input page; and
display, in response to a third input operation on the information input page, the vehicle information, wherein the vehicle information is input via the third input operation.

16. The apparatus according to claim 14, wherein, for the target navigation route, a location label sequence from the start point label to the end point label is displayed on the target navigation route, and
wherein the location label sequence comprises the first energy replenishment location label, and the first energy replenishment location label is located between the start point label and the end point label.

17. The apparatus according to claim 16, wherein, in the location label sequence:
a first estimated energy consumption amount of a first section between the start point label and a next label is not greater than the remaining driving energy amount, and
a second estimated energy consumption amount of a second section between any adjacent energy replenishment location labels is not greater than the storage capacity.

18. The apparatus according to claim 11, wherein the target navigation route is a recommended navigation route or a switched-to navigation route to which a navigation route switching operation points, and
wherein the planned route code is configured to cause at least one of the at least one processor to:
display the at least one navigation route, highlighting the recommended navigation route in the at least one navigation route, and displaying the first energy replenishment location label on the recommended navigation route; and
in response to the navigation route switching operation:
switch from highlighting the recommended navigation route to highlighting the switched-to navigation route, and
switch from displaying the first energy replenishment location label on the recommended navigation route to displaying a second energy replenishment location label on the switched-to navigation route.

19. The apparatus according to claim 18, wherein the first energy replenishment location label and the second energy replenishment location label are different energy replenishment location labels.

20. A non-transitory computer-readable storage medium, storing computer code which, when executed by at least one processor, causes the at least one processor to at least:
display, for performing navigation planning with respect to a vehicle, a start point label indicating a start location of the navigation planning and an end point label indicating an end location of the navigation planning;
display at least one navigation route planned from the start point label to the end point label; and
display, for a target navigation route in the at least one navigation route, a first energy replenishment location label indicating a waypoint of the target navigation route, on the target navigation route, wherein the waypoint corresponds to a driving energy replenishment location for the vehicle.
